(19) United States
(12) Patent Application Publication
(10) Pub. No.: US 2025/0181954 A1
(43) Pub. Date: Jun. 5, 2025

(54) A QUANTUM COMPUTER FOR PERFORMING QUANTUM OPERATIONS

(71) Applicants: BASF SE, Ludwigshafen am Rhein (DE); ROBERT BOSCH GMBH, Stuttgart (DE)

(72) Inventors: Benedikt Matthias SCHOENAUER, Karlsruhe (DE); Peter SCHMITTECKERT, Karlsruhe (DE); Nicolas VOGT, Karlsruhe (DE); Jan-Michael REINER, Karlsruhe (DE); Sebastian ZANKER, Karlsruhe (DE); Michael MARTHALER, Karlsruhe (DE); Thomas ECKL, Renningen (DE); Michael KUEHN, Ludwigshafen (DE)

(21) Appl. No.: 18/843,175

(22) PCT Filed: Mar. 1, 2023
(86) PCT No.: PCT/EP2023/055089

§ 371 Date: Aug. 30, 2024

(30) Foreign Application Priority Data
Mar. 2, 2022 (EP) 22159812.1

(51) Int. Cl. G06N 10/40; G06N 10/20

(52) U.S. Cl. CPC G06N 10/40; G06N 10/20

(57) ABSTRACT

The invention refers to a quantum computer for performing operations based on control signals for determining a solution of a problem comprising a first and a second portion. A fermion operation part is configured to utilize states of quantum elements manipulable by operations. The operations are related to the second portion. A boson operation part is configured to couple bosonic fields to the quantum elements. The coupling is manipulable by operations that are related to the first portion. A manipulation part manipulates the fermion operation part based on operations related to the second portion, and the boson operation part based on operations related to the first portion. A readout part measures an observable of the state of each quantum element representing the state of a respective qubit and bosonic fields, wherein the result of the measurement is indicative of the solution of the problem.

### FIELD OF INVENTION

The invention relates to a quantum computer for performing quantum operations, and an apparatus for determining a solution of a problem using the quantum computer. Further, the invention refers to a system, a method and a computer program product for solving a problem using the quantum computer and a use of the quantum computer.

### BACKGROUND OF THE INVENTION

Quantum computers are generally a completely new kind of computing system that allows utilizing the special behavior of quantum mechanical systems for performing problem calculations that, under the right circumstances, are not performable by ordinary computers in any reasonable time. Moreover, it has already been shown that quantum computers are especially suitable for solving problems that can be related to the quantum mechanical world, i.e., problems that can be translated into a quantum mechanical description. Such problems relate, for instance, to electronic-structure problems, molecular problems, condensed-matter problems, etc. However, also problems outside of the description of physical quantum mechanical systems can be translated into a quantum mechanical description, for instance, coding and decoding problems, complex analysis problems, optimization problems, etc., are known to be translatable to a quantum mechanical description that can be processed by a quantum computer. Examples for the translation of such problems can generally be found, for example, in the article “Quantum algorithms: an overview.” by Montanaro, A., npj Quantum Inf 2, 15023 (2016). However, today's already existing quantum computers often suffer from an inherent sensitivity to errors due to the relaxation and decoherence but also due to imperfections in the controlling of the quantum mechanical systems forming the heart of the quantum computer or due to readout errors. These difficulties with the accuracy of quantum mechanical calculations are directly related to the number of qubits, i.e., quantum mechanical elements comprising at least two states, that are utilized and also to the duration of the quantum mechanical calculation, and further to the amount of qubit operations performed on the quantum mechanical system. Thus, up to now the problems that can be solved on a quantum mechanical computer are often limited by the necessary quantum mechanical calculation efforts. Thus, it would be advantageous, if solutions would be provided that allow the computation of more sophisticated problems on quantum computers with improved reliability.

### SUMMARY OF THE INVENTION

It is an object of the present invention to provide a quantum computer, an apparatus, a method and a computer program product using the quantum computer that allow for an improved reliability and accuracy when solving a problem. Moreover, the present invention allows to solve problems with an increased complexity. Moreover, more kinds of problems can be solved on a quantum computer utilizing the present invention. In particular, it becomes possible to solve problems comprising frequency dependent dynamical interactions of quantities of the problem on a quantum computer, like problems derived from perturbation theory applied to a problem, for example, problems derived utilizing constraint random phase approximation (cRPA).

In a first aspect of the present invention, a quantum computer for performing quantum operations based on control signals for determining a solution of a problem comprising a first and a second portion in a quantum computational calculation is presented, wherein the first portion includes quantities describing the problem that interact with each other and the second portion includes quantities describing the problem that do not interact with each other, wherein the quantum computer comprises i) a fermion operation part configured to utilize quantum mechanical states of quantum elements for forming qubits that are manipulable by operations performed on the quantum elements, wherein the operations are related to the second portion of the problem to be solved during the quantum computational calculation of the problem, ii) a boson operation part configured to couple bosonic fields to the quantum elements, wherein the coupling of the bosonic fields to the quantum elements is manipulable by operations that are related to the first portion of the problem to be solved during the quantum computational calculation of the problem, iii) a manipulation part configured to manipulate a) the fermion operation part such that the states of the quantum elements are manipulated based on control signals indicative of operations that are related to the second portion of the problem to be solved during the quantum computational calculation of the problem, and b) the boson operation part such that the coupling of the bosonic fields to the quantum elements is manipulated based on control signals indicative of operations that are related to the first portion of the problem to be solved such that a quantum mechanical calculation of the problem is performed, and iv) a readout part configured to measure, after the manipulation of the quantum elements and the bosonic coupling for performing the quantum mechanical calculation, at least one observable of the a) quantum mechanical state of each quantum element representing the state of a respective qubit and b) bosonic fields, wherein the result of the measurement is indicative of the solution of the problem.

Since the quantum computer is configured such that the different portions of the problem can be solved by different parts of the quantum computer, different dedicated parts of the quantum computer allow for a more reliable solution. In particular, since the respective interacting portions of the problem do not have to be simulated on the same parts as the non-interacting quantities of the problem, for instance, do not have to utilize alone the quantum elements for performing the calculations for the interacting portion, the calculation becomes less resource-intensive on the hardware, i.e., less entanglement operations are necessary, which require a high degree of control of a quantum mechanical system.

Moreover, since the readout part is configured to measure not only one observable of the quantum mechanical state of each quantum element representing the state of a respective qubit but also to measure the bosonic fields, in particular, a state of a representation of the bosonic fields in the quantum computer, coupled to the respective quantum elements, additional information on the interacting quantities of the problem can be provided. This provides an additional degree of freedom for solving problems on quantum computers. Moreover, since bosonic fields are generally much easier to implement and provide a simpler control concept in the hardware implementation, the quantum mechanical calculations become less error-prone and thus more reliable. Thus, more sophisticated problems can be solved with an improved accuracy.

Generally, the quantum computer can refer to any known realization of the quantum computer, wherein preferred realizations will be described in the following embodiments. For example, the quantum computer can be based on superconducting elements, quantum dots, neutral atoms in optical lattices, nitrogen-vacancy centers in diamond, Bose-Einstein condensates, trapped ions, etc. Due to the plurality of different possible realizations, also the different parts of the quantum computer can be realized in a plurality of different ways. For example, in a superconducting quantum computer the bosonic field can be represented by electromagnetic resonators, whereas in an ion trap quantum computer the bosonic fields can be represented as vibrational modes of the trapped ions. Preferably, the quantum computer refers to a quantum-gate based quantum computer.

The quantum computer is generally adapted to perform quantum operations based on control signals for determining a solution of a problem. Quantum operations can refer to any operations that are performed directly or indirectly on elements of the quantum computer that realize a quantum mechanical description of the problem i.e. that can be described with respect to the quantum mechanical rules instead of the classical physics. However, although an element of the quantum computer can be utilized to realize the quantum mechanical description of a problem, i.e. can be described with the quantum mechanical rules, the element itself does not necessarily have to refer to a quantum mechanical system, e.g. an atom or ion. For example, although in some embodiments electromagnetic resonators are utilized to represent the bosonic fields in the quantum computer that generally follow the classical physical rules, these resonators can in the context of the quantum computer also be described as quantum mechanical quantities. Preferably, the quantum operations comprise all operations that directly or indirectly can influence the states of quantum elements, i.e., qubits, of the quantum computer. For instance, operations performed on the representations of the bosonic fields will, through the coupling between the bosonic fields and the quantum elements, also influence the quantum elements. Thus, also operations performed on the bosonic field representations can refer to quantum operations. The quantum operations hence can comprise operations directly on the quantum elements and thus on the qubits, on the bosonic fields and also on the coupling between the bosonic fields and the quantum elements.

The control signals on which the operations performed by the quantum computer are based can be provided, for instance, by a user via a user interface. The respective user interface can be a common classical computer on which a respective problem is provided and that is adapted to generate the respective control signals. An example, of such an apparatus that can be realized as classical computer and allows for the generation of respective control signals is described with respect to further embodiments of the invention. However, the control signals can also be already stored on a storage unit and then only provided to the quantum computer for further execution.

The problem to be solved by the quantum computer refers to a problem comprising a first and a second portion, wherein the first portion includes quantities describing the problem that interact with each other and the second portion includes quantities describing the problem that do not interact with each other. In an embodiment, the first portion can consist purely of quantities describing the problem that interact with each other and/or the second portion consist purely of quantities describing the problem that do not interact with each other. Preferably, the problem can be provided in form of a quantum mechanical description, wherein in this description it is preferred that the first portion is represented by bosonic fields interacting with fermions and thus describing quantities of the problem that interact with each other and the second portion is described by fermions not interacting with each other and thus describing the non-interacting quantities of the problem. Preferably, the interaction of the quantities describing the problem of the first portion refers to a dynamical interaction, i.e., a frequency or time dependent interaction of the respective interacting quantities, wherein the interaction can also be a retarded or advanced interaction. Further, the problem can comprise a third portion, wherein the third portion also includes quantities describing the problem that interact with each other, in particular, that interact statically with each other, i.e., interact such that there is no time or frequency dependence in the interaction between the respective interacting quantities. The third portion of the problem is preferably also processed by the fermion operation part of the quantum computer. Thus, in some embodiments the third portion of the problem can be regarded as part of the second portion of the problem that is also processed by the fermion operation part of the quantum computer. If the problem is provided in a quantum mechanical description, the third portion of the problem can refer, for instance, to statically interacting fermions, for instance, to a density-density interaction of the fermions.

The fermion operation part is configured to utilize quantum mechanical states of quantum elements in order to form qubits that are manipulable by operations performed on the quantum elements. Generally, the fermion operation part can refer to any hardware of the quantum computer that allows for the performing of operations on the quantum elements. For example, the fermion operation part can comprise the quantum elements themselves and also the components that can be utilized to perform operations on the quantum elements. However, the fermion operation part can also only refer to the hardware part of the quantum computer that is adapted to perform the operations on the quantum elements. In this context, the fermion operation part is adapted such that operations can be performed on the quantum elements that are related to the second portion of the problem to be solved during the quantum computational calculation of the problem. Thus, the fermion operation part allows to perform operations on the quantum elements that are related to the non-interacting quantities of the problem. For example, if a problem is described in a quantum mechanical description, the fermion operation part is preferably adapted to allow for operations performed on the quantum elements that are related to non-interacting fermions of the quantum mechanical description of the problem.

In case the problem comprises a third portion referring to a static interaction of quantities describing the problem, wherein in this case the first portion of the problem refers to dynamical interactions of quantities describing the problem, the fermion operation part can also be configured to perform operations on the quantum elements that are related to the third portion of the problem.

The boson operation part is configured to couple bosonic fields to the quantum elements. Generally, the bosonic fields refer to entities that in the quantum mechanical description of the quantum computer system represent bosonic modes. In some realizations of the quantum computer the coupling between the bosonic fields and the quantum elements can refer to a hardware induced coupling between hardware elements representing the bosonic fields and the quantum elements such that the boson elements, i.e., the hardware representations of the bosonic fields, can influence the quantum elements. However, in other realizations of the quantum computer the bosonic fields can be represented by controllable specific states of the quantum elements, for instance, vibrational modes, such that no additional hardware components are necessary for representing the bosonic fields directly. Preferably, the bosonic fields are non-interacting in the quantum mechanical description such that the representations of the bosonic fields can also be configured to be non-interacting. For example, hardware boson elements can be configured to be non-interacting, i.e. do not have to comprise a connection or coupling between each other.

The boson operation part can generally refer to any hardware component that allows for a coupling of the bosonic fields to the quantum elements, for instance, that allows for performing operations on the quantum elements and/or optionally on the boson elements that lead to a coupling of the bosonic fields with the quantum elements. In this context, it is again noted that the bosonic fields themselves can be realized by hardware elements but can also be realized as specific states of one or more elements of the quantum computer, for instance, of the quantum elements themselves. The boson operation part can accordingly comprise boson elements that are adapted to represent the bosonic fields during the quantum computational calculation of the problem and further the hardware necessary for coupling the boson elements to the quantum elements and also the hardware elements that allow for a manipulation of the coupling and, preferably, of the boson elements. However, in other embodiments the boson operation part can also refer only to the hardware that is adapted to allow for the coupling of the bosonic fields to the quantum elements and the hardware parts that generally allow for a manipulation of the coupling. For example, if the quantum computer refers to an ion-trap system quantum computer, the bosonic fields can be represented by vibrational modes of ions forming the quantum elements and the coupling and/or manipulation of the coupling can be provided by control lasers that can provide laser light with a specific wavelength to the trapped ions.

The coupling of the bosonic fields to the quantum elements is manipulable by operations that are related to the first portion of the problem to be solved during the quantum computational calculation of the problem. Thus, in particular the operations relate to the interacting quantities describing the problem, in particular, to dynamically interacting quantities describing the problem. Accordingly, the interacting quantities of the problem are represented in the quantum mechanical computation system as bosonic fields interacting with quantum elements. If the problem is provided in a quantum mechanical description referring to a fermion-boson system as described above, the interacting quantities can be mapped to the interaction between the bosons and fermions. This kind of representation of the interacting quantities allows utilizing hardware components that are much easier to handle and manipulate than the quantum elements themselves for representing at least a part of the quantities of the problem. Thus, qubit operations referring to performing operations directly on the quantum elements can be reduced, since qubit operations that otherwise have to represent the interaction between the quantities can be replaced with quantum operations performed on the coupling and/or the bosonic fields. Since the number of qubit operations performed on the quantum elements is related to the accuracy of the solution of the problem, by utilizing the coupled bosonic fields for solving a problem with interacting quantities, the accuracy of the respective result can be improved.

A manipulation part is configured to a) manipulate the states of the quantum elements and b) the coupling of the bosonic fields to the quantum elements. Generally, the manipulation is based on control signals indicative of the operations that are intended to be performed on the quantum elements or the coupling of the bosonic fields. Preferably, the quantum elements are manipulated based on control signals indicative of operations that are related to a second portion of the problem and the coupling of the bosonic fields is manipulated based on control signals indicative of operations that are related to the first portion of a problem. The manipulation part can generally refer to any hardware that is configured to manipulate the respective state of the quantum elements or the coupling of the bosonic fields based on control signals. Thus, the manipulation part can be regarded as referring to an interface between a) software and/or hardware components utilized to provide the control signals and b) the fermion operation part and boson operation part of the quantum computer realizing the quantum computational calculation. For example, the manipulation part can refer to a controller of the fermion operation part and/or the boson operation part. In case the quantum computer refers to an ion trap in which the operations on the ions are performed by a laser, the manipulation part can be realized as a controller of the laser.

The readout part is configured to measure, after the performed quantum mechanical calculation, at least one observable of the quantum mechanical state of each quantum element representing the state of a respective qubit and further to measure the bosonic fields, i.e., to measure a state of a representation of the bosonic fields in the quantum mechanical calculation, for instance, a state of a boson element or of the specific state of the quantum elements representing the bosonic fields. Generally, the one or more observables that are measured by the readout part depend on the respective realization of the quantum computer. For example, if the quantum computer refers to an ion trap, the observable measured for the quantum elements can refer to the electronic state of the respective quantum element, whereas the observable for a bosonic field can refer to the respective vibration mode of an ion in the ion trap. However, also depending on the problem the energies of the respective systems can be measured as observables. Generally, the result of the measurement of the respective observables is indicative of the solution of the problem. In particular, depending on the translation of the problem into the quantum mechanical description, the result of the measurement can be utilized during further calculations or can be translated back from the quantum mechanical solution to the respective “real-world” solution of the problem.

In an embodiment, the quantum computer further comprises a controlling unit configured for providing control signals for controlling the manipulation part to manipulate a) the fermion operation part such that the states of the quantum elements are manipulated based on operations that are related to the second portion of the problem to be solved during the quantum computational calculation of the problem, and b) the boson operation part such that the coupling of the bosonic fields to the quantum elements is manipulated based on operations that are related to the first portion of the problem to be solved such that a quantum mechanical calculation of the problem is performed. Generally, the controlling unit can be realized as dedicated hardware and/or software that is adapted to provide the control signals as defined above to the manipulation unit, wherein the manipulation unit can be regarded as acting as an interface between the controlling unit providing the specific control signals and the fermion operation part and the boson operation part of the quantum computer. However, the controlling unit and the manipulation unit can also be realized as the same hardware and/or software combining the functions of the controlling unit and the manipulation unit. For example, the controlling unit can be configured to provide control signals that are based on operations that have been determined with respect to a specific problem to be solved by the quantum computer to the manipulation unit that then manipulates the fermion operation part and the boson operation part to perform the operations. Moreover, since the controlling unit provides control signals that are specifically determined with respect to the second portion of the problem that are dedicated to manipulate the states of the quantum elements of the fermion operation part and/or further provide the control signals that are determined with respect to the first portion of the problem that are dedicated for manipulating the coupling of the bosonic fields and, optionally, of the bosonic fields themselves, the hardware part controlled by the respective control signals can accordingly be regarded as being part of the fermion operation part and/or the boson operation part. Thus, the controlling of the respective hardware components of the quantum computer, as defined above, can define which parts of the quantum computer belong to the fermion operation part and which parts of the quantum computer belong to the boson operation part. In this context it is noted that some parts of a quantum computer can even be regarded as belonging to both the fermion operation part and the boson operation part.

In an embodiment, the bosonic coupling of the bosonic fields to the quantum elements is configured to be adaptable to represent a specific coupling of the quantities of the first portion of the problem during the quantum computational calculation, wherein the manipulation part is further configured to adapt the coupling. In this context, the manipulation of a coupling of the bosonic fields to the quantum elements is regarded as referring to the general possibility of providing and controlling such a coupling, for instance, of determining by utilizing quantum operations, which bosonic fields should be coupled to which quantum elements, and the possibility of performing operations on the coupling of the bosonic fields and, optionally, on the bosonic field itself. The adaptation of the coupling of the bosonic fields to the quantum elements refers to the possibility of specifically adapting the effect of bosonic fields on at least one quantum element to which it is coupled, for instance, by performing respective operations or by adapting a hardware setting, for instance, utilizing a switch, prior or during the quantum mechanical calculation. How the effect of the bosonic fields on the quantum elements is determined is generally based on the respective realization of the quantum computer. For example, in case of an ion-trap quantum computer, in which the bosonic fields are represented by vibrational modes of the ions, the effect on the quantum elements represented by the electronic state of the ions can be controlled by controlling the environment of the ions, for instance, by utilizing a laser such that the energy transfer from the vibrational modes to the electronic states can be adapted. However, in other realizations of the quantum computer, the effect of the bosonic fields on the quantum elements to which they are coupled can be controlled in other ways.

In an embodiment, the boson operation part is configured to couple at least one bosonic field to each quantum element forming a qubit. In a preferred embodiment, the boson operation part is configured to couple more than one bosonic field to each quantum element forming a qubit, preferably four bosonic fields to each quantum element. It is further preferred that the operation part is configured to couple a bosonic field to only one quantum element forming a qubit. Thus, each quantum element can be coupled to one or more dedicated bosonic fields that are only coupled to one quantum element. This has the advantage that the interaction between the bosonic fields and the quantum element can be controlled more accurately such that unintentional interactions can be avoided. Since unintentional interactions can lead to inaccuracies or errors in the quantum mechanical calculation, this allows to increase the accuracy of the result of the quantum mechanical calculation.

In the following, preferred alternative embodiments of the quantum computer and the respective defined parts of the quantum computer as defined above will be described. In a first preferred alternative, the quantum computer refers to a superconducting quantum computer, in which the quantum elements are realized as superconducting circuits and the coupling of the bosonic fields to the quantum elements by providing electromagnetic resonators that are preferably also based on superconducting technologies, coupled via electromagnetic fields to the superconducting circuits. Preferably, in this embodiment the boson operation part comprises the resonators as boson elements, wherein the electromagnetic fields of the resonators represent the bosonic fields during a quantum mechanical calculation. In particular, the electromagnetic resonators coupled to the superconducting circuits refer to additional electromagnetic resonators that are specifically provided for representing the bosonic fields. In this context, it is noted that electromagnetic resonators utilized in a superconducting quantum computer for measuring the state of the superconducting quantum elements, i.e. for reading out the qubits, that are regarded as being, for instance, part of the readout unit, can generally not be utilized for representing the bosonic fields. The respective readout operations performed on the readout resonators would destroy the state of the bosonic field represented by the resonator and also the coupling of the bosonic fields to the quantum elements during the readout and thus make the results of the readout unreliable. Accordingly, the electromagnetic resonators that provide the coupling to the superconducting circuits for coupling the bosonic fields to the quantum elements do not refer to electromagnetic resonators utilized for the readout of the superconducting circuits and thus are additional electromagnetic resonators. In this embodiment the boson coupling part can comprise or utilize a microwave source for manipulating electromagnetic fields generated by the resonators and thus for representing the bosonic fields. Moreover, the microwave source can also be used to manipulate a coupling between an electromagnetic field generated by a resonator and the superconducting circuits forming the quantum elements.

In a second alternative preferred embodiment, the quantum computer refers to an ion-trap quantum computer, wherein the quantum elements are realized as ions trapped in an ion trap and the coupling of the bosonic fields to the quantum elements is realized as a coupling of vibrational modes of the trapped ions to electronic states of the trapped ions forming the qubits. In this embodiment, the boson operation part can comprise or utilize a laser for manipulating the coupling between the electronic states, i.e. modes, of the ions and the vibrational modes. For example, utilizing laser light with respective wavelengths, i.e. frequencies, and amplitudes that are in resonance or close to a resonance of the modes, a coupling can be turned on or turned off or a strength of a coupling can be manipulated. In particular, the coupling of the electronic modes and the vibrational modes refers to the transfer of energy between these modes. Thus, if no coupling is present, substantially no energy is transferred between the modes, whereas, if a coupling is present, the amount of transferred energy determines the strength of the coupling. Preferably, the laser is adapted to be tunable, in particular, the laser can be tuned to a resonance frequency of the quantum mechanical problem description, i.e. a resonance frequency of the quantum elements of the ion-trap. The resonances utilized in this context preferably refer to the carrier transition resonance, the red sideband resonance and the blue side band resonance. The carrier transition resonance refers to a frequency of the transition of a trapped ion between electronic states used in the quantum computer calculation without initiating an energy transfer from or to vibration modes of the ions. The red sideband transition resonance refers to a frequency allowing for a transfer of energy from an electronic state of the ion to a vibration mode of the ion in the ion trap or vice versa. The blue sideband transition resonance refers to a frequency allowing for a simultaneous excitation from a lower energy electronic state of an ion to a higher energy electronic state of the ion and an increase of excitations in the vibration mode or allowing for a simultaneous transition from a higher energy electronic state of an ion to a lower energy electronic state of the ion and a decrease of excitations in the vibration mode so that both can be manipulated at the same time.

In a third alternative preferred embodiment, the quantum computer can refer to any one type of quantum computer and the bosonic coupling is in this case realized by performing additional coupling operations on the quantum elements forming the qubits for representing the bosonic fields and the coupling of the bosonic fields to the quantum elements. In this embodiment, it is preferred that the quantum elements utilized for representing a bosonic field are coupled to each other such that two-qubit operations can be applied and that at least one of the quantum elements representing the respective bosonic field is coupled to a quantum element representing the interacting fermion, i.e. the fermion interacting with the respective bosonic field such that the first portion can be represented. Utilizing such a coupling configuration allows to decrease the control and manipulation requirements on the hardware of the quantum computer compared with, for instance, a full-interacting fermion calculation without bosonic fields. Moreover, the circuit depth for performing the quantum mechanical calculation of the problem can be decreased in this configuration, i.e. the number of quantum operations that have to be applied for simulating the bosonic fields can be decreased compared to a simulation of the problem with other coupling configurations.

In a further aspect of the present invention, an apparatus for providing control signals for controlling a quantum computer for determining a solution of a problem comprising a first and a second portion in a quantum computational calculation using, preferably, the quantum computer as described above, is presented, wherein the first portion includes quantities describing the problem that interact with each other and the second portion includes quantities describing the problem that do not interact with each other, wherein the apparatus comprises i) a problem providing unit for providing a problem description indicative of the problem comprising the first and second portion to be solved, ii) a translation unit for translating the problem description into a representative operation description indicative of a sequence of operations comprising a) second operations to be applied to a fermion operation part of the quantum computer and b) first operations to be applied to a boson operation part of the quantum computer, wherein the first operations are determined based on the first portion of the problem and the second operations are determined based on the second portion of the problem, iii) a controlling unit for generating control signals for controlling a manipulation part of the quantum computer to manipulate a) the fermion operation part such that the states of the quantum elements are manipulated based on the second operations, and b) the boson operation part such that the coupling of the bosonic fields to the quantum elements is manipulated based on the first operations such that a quantum mechanical calculation of the problem is performed, wherein the controlling unit is further adapted to provide control signals for controlling a readout part of the quantum computer to readout one or more observables after the performance of the quantum mechanical calculation indicative of the solution of the problem, and optionally iv) a result determination unit for determining, based on the one or more readout observables, the solution for the problem.

Generally, the apparatus can be realized in form of software or hardware or a combination thereof, wherein the hardware can refer to any known dedicated or general classical computer hardware. For example, the apparatus can be realized as any known computational device, like a PC. However, the apparatus can also be realized as a cloud environment, computational network, etc., such that at least parts of the apparatus can also be realized as a network solution and thus can be spread over a plurality of computation devices. The apparatus is adapted to, preferably, use a quantum computer with respect to any of the above described embodiments for performing the quantum computational calculation for determining a solution of the problem. However, the quantum computer is not part of the apparatus itself.

The problem providing unit is adapted to provide a problem description indicative of the problem comprising the first and second portion to be solved. In particular, the problem providing unit can refer to a storage unit on which the problem description is already stored. However, the problem providing unit can also comprise an input unit with which, for instance, a user, can indicate a problem description of the problem to the problem providing unit. The problem description can refer to any form of description of the problem that allows to determine the quantities describing the problem and the form of interaction between these quantities. Preferably, the problem description refers to a mathematical description of the problem. However, the problem description can also refer to any other unambiguous form of notation of the problem. In a preferred embodiment, the problem description is a quantum mechanical description of the problem. A quantum mechanical description allows to represent the problem in terms of quantities following the quantum mechanical rules, i.e. a representation of the problem in the quantum mechanical world.

The translation unit is adapted to translate the problem description into a representative operation description. In particular, the translation unit is adapted to determine from the problem description the representative operation description such that it comprises a sequence of operations to be performed by the quantum computer to perform the quantum computational calculation. In particular, the sequence of operation comprises a) second operations to be applied to the quantum elements of a fermion operation part of the quantum computer, and b) first operations to be applied to a coupling of bosonic fields to the quantum elements and optionally to a representation of the bosonic fields themselves, provided by a boson operation part of the quantum computer. Thus, the problem is divided by dividing the sequence of operations to different parts of the quantum computer. Following the above already described idea of the quantum computer, the first operations are, in particular, determined based on the first portion of the problem and the second operations are determined based on the second portion of the problem. Accordingly, the fermion operation part of the quantum computer is utilized to perform operations related to non-interacting quantities of the problem and the boson operation part is utilized to perform operations related to the interacting part of the problem. In case the problem further comprises a third portion referring to quantities describing the problem that interact statically, the translation unit can further be adapted to translate the problem description to a representative operation description comprising a sequence of operations comprising further third operations that are determined based on the third portion of the problem and are to be applied also to the quantum elements of the fermion operation part.

In case the problem description is not provided in form of a quantum mechanical description, the translation unit is preferably further adapted to translate the problem description accordingly, e.g. to map the problem description to a description of a quantum mechanical system that can generally be simulated by the respective chosen quantum computer, for example, by mapping the problem description to a Hamiltonian of a quantum mechanical system that defines similar relations between and influences on quantities as the problem. Thus, for instance, an optimization problem referring to the field of optimizing production parameters for producing a product, like temperature, pressure, flow velocity, etc., can be translated into a quantum mechanical description representing the problem in the quantum mechanical world of the quantum computer. In such a case, for instance, Ising models can be utilized for the translation. However, if the problem already refers to a quantum mechanical problem, for instance, an electronic-structure problem, this particular step of translating the problem into a quantum mechanical description can be omitted. Generally, the translation unit can be adapted to translate the problem description based on predetermined rules or a predetermined model for specific problem categories or can be adapted to translate the problem description in an interactive process based on user input. In the case of an interactive process the user can, for instance, be provided with a user interface that allows the user to select different problem categories, like, optimization problem, electronic-structure problem, etc. to determine the category of the provided problem and can further select a respective set of rules or model that shall be applied for translating the provided problem. However, also other interaction can be facilitated by a user interface for translating the problem. Moreover, for translating the provided problem, the translation unit can also be adapted to access a storage on which translations for specific problems are already stored, for instance, for problems that have already been solved before, e.g. for different parameters.

The controlling unit is configured to generate control signals for controlling the manipulation part of the quantum computer in accordance with the determined sequence of operations. Generally, if the quantum computer itself already provides a controlling unit that is adapted to control the manipulation part such that the states of the quantum elements are manipulated based on the second operations and the coupling of the bosonic fields is manipulated based on the first operations, the controlling unit of the apparatus can be omitted. In this case, the translation unit only provides a determined sequence of operations to the controlling unit that can be already part of the quantum computer, for instance, as form of a dedicated hardware. However, the controlling unit can also be adapted to work together with a controlling unit of the quantum computer. For example, the controlling unit of the apparatus can be adapted to provide the control signals in a generally known form, whereas the controlling unit of a quantum computer can be adapted to translate the common control signals into dedicated control signals specific for the hardware of the respective quantum computer. Thus, the controlling unit can be regarded as referring to an interface between the quantum computer, in particular the hardware of the quantum computer, and the software for solving a respective problem running on a generally known classical computer. Further, the control unit is adapted to control the readout part of the quantum computer such that the one or more observables are measured, i.e. readout, after the performance of the quantum mechanical calculation. In particular, the controlling unit is adapted to receive the readout of the readout part and provide the readout, for instance, to the result determination unit that can be part of the classical computational environment. Thus, also for the readout a controlling unit together with the readout part can act as an interface between the classical electronic computer environment and the quantum computer.

The result determination unit is adapted to determine based on the one or more readout observables the solution of the problem. For example, the result determination unit can be adapted to translate the one or more readout observables that are indicative of a solution to the representative quantum mechanical description of the problem to the respective solution in the problem description, for example, utilizing the same manner of translation that has been used to translate the problem description into the representative quantum mechanical description. Additionally or alternatively, the result determination unit can be adapted to perform further calculations or manipulations based on the one or more readout observables to determine the solution of the problem. For example, averaging processes, error correction processes, further optimization processes, etc. can be applied based on the one or more readout observables to determine the solution of the problem. Generally, the solution of the problem can then be provided to a user, for instance, via an output unit like a display, or can be further utilized, for example, for directly controlling a production of a product with respective optimized production parameters.

In an embodiment, the problem providing unit is adapted to provide a problem description indicative of a problem comprising a portion with interacting quantities describing the problem, wherein the system comprises further a transformation unit adapted to transform the interacting portion of the problem description into a problem description comprising a first and a second portion. Depending on the respective problem description the transformation unit can utilize, for instance, mathematical methods and/or approximations or logical functions that allow to determine a description of the problem that allows a splitting of the interaction into a first and second portion. For example, the interacting quantities of the problem can be transformed into new quantities from which some are interacting and others are non-interacting. Additionally or alternatively, approximations can be applied to the problem description approximating at least some of the interacting quantities as non-interacting quantities. Generally, the transformation of the problem from a purely interacting problem into a problem that can be described in form of a first and a second portion allows to utilize the above described hardware of the quantum computer in an optimal way such that less operations have to be performed on the quantum elements of the quantum computer itself. This leads to a higher accuracy and a technical simplicity compared to a case in which it is tried to directly solve the problem by simulating the interacting quantities without a transformation.

In a preferred embodiment, the problem description is representable by a quantum mechanical description comprising fermion-fermion interactions and the transformation unit is adapted to transform the problem description into a problem description representable by a quantum mechanical description comprising boson-fermion interactions as first portion of the problem and non-interacting fermions as second portion of the problem. Moreover, the representation of the non-interacting bosonic fields can be regarded as also being part of the first portion of the problem. Generally, the transformation is preferably adapted to transform fermion-fermion interactions of the quantum mechanical description of the problem into fermion-boson interactions defining a connection between the fermion-fermion interaction, the bosonic field resonance frequencies and the fermion-bosonic field coupling strength. Optionally, the transformed quantum mechanical description can further comprise statically interacting fermions as third portion. For example, the problem description can directly be provided as a quantum mechanical description relating to a fermion-fermion interaction problem or, the problem description can generally be represented in a quantum mechanical description that relates to a fermion-fermion interaction problem. Before the transformation unit transforms the problem, it is preferred that the transformation unit is adapted to translate the problem description into the quantum mechanical description such that the transformation unit can be adapted to utilize for transforming the problem respective quantum mechanical rules and algorithms. However, the transformation unit can also be adapted to transform the problem description in any other form or notation that unambiguously describes the problem, wherein in this case the respective utilized transformation can be based on rules that have been deduced from the quantum mechanical transformation of the problem in the quantum mechanical description. In a preferred embodiment, the transformation unit is adapted to transform the problem description referring to a quantum mechanical description comprising fermion-fermion interactions by utilizing a Hubbard-Stratonovich transformation. However, also other known transformation algorithms can be utilized.

In an embodiment, the problem description comprises at least portions that are representable by a quantum mechanical description comprising static fermion-fermion interactions as third portion and the transformation unit is adapted to approximate these parts of the problem by applying a constrained random phase approximation (cRPA) to the quantum mechanical description of the problem. This allows to reduce the number of fermionic states that have to be simulated during the quantum mechanical calculation of the problem and thus also the number of operations and the number of quantum elements used in the calculation. Thus, even more complex and larger problems, i.e. problems represented by a larger number of fermionic states, can be calculated on the quantum computer. Generally, a cRPA allows to differentiate between fermions that take an active part in the problem solution and fermions that can be considered as general background to the fermions that take an active part. For example, if reactions between different molecules shall be simulated in the problem, only the electrons in the outer orbitals, i.e. the valence orbitals, can be considered as taking an active part in the problem solution, whereas electrons in the inner orbitals of the atom can be considered as providing only a background for the electrons in the outer orbitals. Another example are transition metal oxide materials, where only the narrow d-states close to the Fermi energy take part in the active part of the calculation, whereas the other electronic states are considered as effective screening background by cRPA. Applying a constrained random phase approximation allows in such a context to describe the background fermions, instead of individuals, as a charge cloud that interacts with the active fermions, in particular, provides a screening effect for the active fermions.

In an embodiment, the problem description refers to a quantum mechanical description and the translation unit is adapted to transform the quantum mechanical description of the problem into a rotating reference frame, in particular, by applying a rotating wave approximation, before the translation into the representative operation description. Preferably, the translation unit is adapted to further apply the rotating wave approximation to the quantum mechanical description in the rotating reference frame. Utilizing the rotating reference frame and the rotating wave approximation for the quantum mechanical description allows for a simplification of different time scales resulting from different parts of the hardware acting on these different time scales. For example, the fermion operation part can act on a different time scale as the boson operation part depending on the actual realization of the quantum computer. The rotating reference frame and the rotating wave approximation allow for a much easier synchronization of these different time scales during the quantum mechanical calculation of the problem.

In an embodiment, the problem description refers to a quantum mechanical description and the translation unit is adapted to apply a low-rank decomposition to the quantum mechanical description of the problem before the translation into the representative quantum description. Applying a low-rank decomposition to the quantum mechanical description allows to reduce the number of necessary representations of the bosonic fields and thus allows for an easier controlling and more efficient quantum mechanical calculation of the problem.

In an embodiment, the problem description comprises at least portions that are representable by a quantum mechanical description comprising an interacting cluster with static local fermion interactions embedded in static non-local long-range interactions, which reach outside the cluster, as third portion of the problem and wherein the transformation unit is adapted to approximate these non-local long-range portions of the problem by utilizing a Hubbard-Stratonovich transformation. Generally, the non-local long-range interactions can be determined based on a predetermined range parameter that differentiates non-local interaction from local interactions. However, the respective parts of the problem can also be predetermined, for instance, by a user defining which interactions refer to non-local interactions and which refer to local interactions. Furthermore, it can be defined that all interactions outside an interacting cluster are to be referred to long-range interactions such that the definition of a cluster directly also defines which interactions are long-range interactions. It is further preferred that the parts of the problem resulting from the utilized Hubbard-Stratonovich transformation, in particular, the resulting propagator terms, are calculated by utilizing a quantum computer and the respective results of the calculation are then utilized in a dynamical mean field theory (DMFT) self-consistency loop, i.e. an iteration process, to calculate the solution of the complete problem.

In an embodiment, the translation unit is adapted to translate the problem description into a representative operation description that comprises operations causing a bosonic peak broadening by including operations into the sequence of operations that utilize ancilla qubits and/or additional external electromagnetic fields that are configured to manipulate the coupling of the bosonic fields to the quantum elements. Generally, the interaction between the bosonic fields and the fermions is frequency dependent, wherein the frequency dependence comprises ranges in which the interaction is strong and frequency ranges in which the interaction is weak. Frequency ranges in which the interaction is strong form in a frequency dependence diagram peaks and are referred herein as bosonic peaks. The respective peaks have a certain width, i.e. quality factor, that is determined by the respective formulation of the quantum mechanical description of the problem and the representation on the quantum computer depends, for instance, on the construction and type of the quantum computer. However, the width and thus the quality factor of the bosonic peaks can be manipulated, in particular, broadened, by utilizing for instance ancilla qubits and/or additional external electromagnetic fields that are configured to manipulate the coupling of the bosonic fields to the quantum elements. Broadening the bosonic peaks has the advantage that it becomes technically easier to configure the quantum computer such that the respective frequency dependence can be realized on the quantum computer, for example, the technical requirements on resonators can be decreased, if the interacting frequency range, i.e. the bosonic peaks, are broader. Thus, realizing a bosonic peak broadening allows to decrease the technical requirements on the hardware of the quantum computer for the calculation of specific problems and thus can lead to the possibility of calculating more and different problems on a specific quantum computer.

In a further aspect of the invention a system for determining a solution of a problem in a quantum computational calculation is presented, wherein the system comprises i) a quantum computer as described above, and ii) an apparatus as described above, wherein the apparatus further comprises a result determination unit for determining, based on the one or more readout observables, the solution for the problem.

In a further aspect of the invention, a method for providing control signals for controlling a quantum computer for determining a solution of a problem comprising a first and a second portion in a quantum computational calculation is presented, wherein the first portion includes quantities describing the problem that interact with each other and the second portion includes quantities describing the problem that do not interact with each other, using the quantum computer as described above, wherein the method comprises i) providing a problem description indicative of the problem comprising the first and second portion to be solved, ii) translating the problem description into a representative operation description indicative of a sequence of operations comprising a) second operations to be applied to a fermion operation part of the quantum computer and b) first operations to be applied to boson operation part of the quantum computer, wherein the first operations are determined based on the first portion of the problem and the second operations are determined based on the second portion of the problem, iii) generating control signals for controlling a manipulation part of the quantum computer to manipulate a) the fermion operation part such that the states of the quantum elements are manipulated based on the second operations, and b) the boson operation part such that the coupling of the bosonic fields to the quantum elements is manipulated based on the first operations such that a quantum mechanical calculation of the problem is performed, iv) providing control signals for controlling a readout part of the quantum computer to readout one or more observables after the performance of the quantum mechanical calculation indicative of the solution of the problem, and optionally v) determining, based on the one or more readout observables, the solution for the problem.

In a further aspect of the invention, a computer program product for providing control signals for controlling a quantum computer for determining a solution of a problem is presented, wherein the computer program product comprises program code means for causing the apparatus as described above to execute the method as described above.

In a further aspect of the invention, the use of a quantum computer as described above, an apparatus as described above, a system as described above, a method as described above, and a computer program product as described above, for solving problems referring to electronic-structure problems is presented. The electronic-structure problems can refer, in particular, to molecular problems and condensed-matter problems. Preferably, the molecular problems comprise problems referring to at least one of metal-organic compounds containing transition metals including lanthanides and actinides, chelating agents interacting with metals, catalysts, biomolecules with active centers, macromolecular systems and transition-metal compounds in solution or embedded in an environment. Preferably, the condensed-matter problems comprise problems referring to at least one of transition metal oxides and rare earth elements, e.g., Perovskites, for example, used in solid oxide fuel cells, oxide-based battery cathodes, hard magnets for electric engines, catalysts for fuel cells, transition metal heterostructures for sensors, magnetic-semiconducting sandwich structures for spintronics and high-temperature superconductors.

It shall be understood that the apparatus as described above, the system as described above and the computer program product as described above have similar and/or identical preferred embodiments, in particular, as defined in the dependent claims.

It shall be understood that a preferred embodiment of the present invention can also be any combination of the dependent claims or above embodiments with the respective independent claim.

These and other aspects of the present invention will be apparent from and elucidated with reference to the embodiments described hereafter.

### BRIEF DESCRIPTION OF THE DRAWINGS

In the following drawings:

FIG. 1 illustrates a state representation of a qubit as used in a quantum computing device,

FIG. 2 illustrates a schematic example of a quantum computing device with qubits as calculation unit,

FIG. 3 illustrates a schematic example method for generating a control signal to perform operations on the quantum computing device and for processing measurement signals from the quantum computing device,

FIG. 4 illustrates a schematic example of a hybrid system including a classical and a quantum computing device,

FIG. 5 illustrates a schematic example of a quantum computing device based on superconductors,

FIG. 6 illustrates a schematic example of a quantum computing device based on trapped ions,

FIG. 7 shows schematically and exemplarily an embodiment of a system for determining a solution of a problem,

FIG. 8 shows schematically and exemplarily a flow chart of a method for determining a solution of a problem, and

FIG. 9 shows schematically and exemplarily an example of a sequence of operations applicable to perform a quantum mechanical calculation.

### DETAILED DESCRIPTION OF THE DRAWINGS

In the following first a short introduction into the general basic principles of quantum computers and the performance of calculations of quantum computers will be provided. Further, general principles can also be found in “Quantum Computation and Quantum Information: 10^{th} Anniversary Edition”, M. A. Nielsen and I. L. Chuang (2010).

Classical computing devices use processors which are based on transistors. The state of each transistor has two controllable states 1 or 0 representing a digital binary or a bit. To perform operations on a classical computing device a human readable program code is translated via a compiler into machine-readable instructions. Machine-readable instructions are control signals, e.g. voltage settings, for each transistor. Representations of the machine-readable instructions may include binary or hexadecimal representations. Based on such machine-readable instructions, the operations are performed on the processor of a classical computing device.

Quantum computation is a relatively new computation method that uses quantum effects, such as superposition and entanglement, to perform certain computations more efficiently than classical digital computers. In contrast to digital computers, which represent information in the form of bits (e.g., “1” or “0”), as described above, quantum computing devices, i.e. quantum computers, use qubits, i.e. quantum bits, to represent information. Quantum computing devices are based on quantum elements adhering to the physics of quantum mechanics, such as superconductors, ions, atoms, quantum dots, photons, particle spins, bosons or the like. These quantum elements may be manipulated in a controlled manner to perform operations.

Although qubits and their manipulation may be described in terms of their mathematical properties, each such qubit may be implemented in a physical quantum element in any of a variety of different ways. Examples of such quantum elements include superconducting materials, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or any medium that exhibits qubit behavior comprising quantum states and transitions there between that can be controllably induced or detected.

Generally, for any given physical quantum element that implements a qubit, any of a variety of properties of that physical unit may be chosen to implement the qubit. For example, if electrons are chosen to implement qubits, then the x, y or z component of an electron spin degree of freedom can be chosen as the property of such electrons to represent the states of such qubits. For any particular degree of freedom, the physical quantum elements can be controllably put in a state of superposition or entanglement and measurements can then be taken in the chosen degree of freedom to obtain readouts of qubit values.

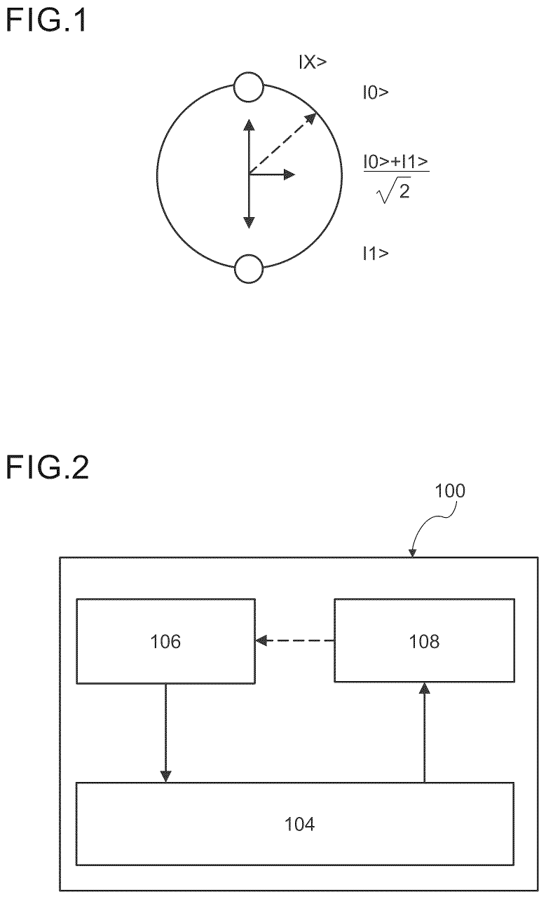

In contrast to transistors of classical computing devices each quantum element of quantum computing devices can not only take the basis states |1 [symbol] or |0 [symbol] but also any superposition of such basis states, such as state |X [symbol] . The state of each quantum element is represented by a state of a quantum bit, i.e. qubit, as illustrated in the two-dimensional simplification of FIG. 1. To represent such states Dirac notation is commonly used in quantum mechanics. In Dirac notation a state in a n dimensional, complex vector space, such as a Hilbert space, is represented in bracket notation, for example |X [symbol] . According to conventional terminology, the superposition of “0” and “1” states in a quantum computing device can be represented as α|0 [symbol] +β1 [symbol] . The states “0” and “1” or bits of the classical computing device are similar to the basis states |0 [symbol] and |1 [symbol] or quantum bits of the quantum computing device, respectively. The value |α|² represents the probability that the qubit will be measured in the |0 [symbol] state, while the value |β|² represents the probability that the qubit will be measured in the |1 [symbol] state. If more than one qubit is present, two or more qubits may be entangled. Entanglement means that the state of one qubit is dependent on the state of at least one other qubit and vice versa, wherein further in the entangled state the respective qubits cannot be regarded as individual qubits anymore. Generally, a register of N qubits in a quantum computer can be put into a superposition of basis states at once whereas a register of N classical bits can only be in a single basis state at once. Thus, in contrast to classical computing devices on a quantum computing device 2^{N} basis states can be manipulated and processed simultaneously allowing for exponential intrinsic parallelism.

To perform operations on the quantum computing device the computational method to solve a given problem may be translated into qubit operations, which may be translated into control signals for manipulating qubits. Representations of the machine-readable instructions may include common quantum mechanical representations of operations in the Hilbert space. Depending on a specific realization of the quantum computer different representations of the qubit states may be chosen. Any state preparation on the quantum computing device may be represented by an operation acting on the qubit states. An operation may be translated into control signals to control a respective part of the quantum computer, which depend on the type of quantum computing device used. This way based on the operation acting on the qubit states, the operations may be performed on the quantum equivalent of a classical processor as part of the quantum computing device.

The operations acting on the qubit states may generally be one- or multi-qubit operations. A one-qubit operation may change the state of one qubit e.g., into a specific superposition which corresponds to a rotation of the vector |X [symbol] as illustrated in FIG. 1. For example, in a superconducting quantum computer this can be accomplished by microwave pulses or in a trapped-ion quantum computer by irradiation of the ion with a laser beam. A multi-qubit operation may create entanglement between two or more qubits. For example, in a superconducting quantum computer this may be achieved by connecting qubits via an intermediate electrical coupling circuit or in a trapped-ion quantum computer via controlling the collective vibrations of the trapped ions.

Generally, to prepare operations for solving a given problem a respective quantum mechanical representation of the problem may be translated into qubit operations, which are carried out to prepare a solution of the given problem. After the preparation of the predetermined solution, i.e. after the application of the operations to the qubits of the quantum computer, a projective measurement of all individual qubits is carried out returning either 0 or 1 for each qubit. On the quantum computing device this measurement is achieved by applying a hardware-specific readout protocol of a series of readout operations including control pulses and monitoring the response to control pulses. For example, a superconducting qubit may be coupled to a hardware resonator. The measured shift of the resonator frequency allows to determine the state of the qubit as this shift depends on the state of the coupled qubit. In case of trapped ions, for example, an optical readout may be used, e.g. the state of the qubit is 1 if the ion emits light or 0 if the ion does not emit light or vice versa. This way qubits may be used to implement logical circuits or gates as in classical computing devices.

In FIG. 2 a schematic example of a quantum computer is illustrated. The quantum computing device 100 shown in FIG. 2 includes a quantum register 104 configured to perform the quantum computation, a manipulation part 106 configured to manipulate the quantum register, in particular, quantum elements forming the qubits, and a readout part 108 configured to collect measurement signals from the quantum register 104 for reading out the qubits after a quantum mechanical calculation. The manipulation part 106, in particular, provides manipulation signals for manipulating the quantum register, wherein the manipulation signals are generated based on received control signals that are determined based on the respective operations that should be performed on the qubits. In some embodiment a feedback loop between the manipulation part 106 and measurement part 108 can be provided. In contrast to classical computing, where one measurement cycle provides the state of a transistor, quantum computing includes performing multiple measurement cycles to provide a probability density or a probability for the qubit states.

The quantum register 104 can be based on different quantum elements representing the qubits. In some embodiments the qubits may be implemented by photons as quantum elements. Such optical quantum computing devices may include lasers that generate photons that are provided to a waveguide. A beam splitter can be provided for manipulating the photon states based on manipulation signals such as a mechanical rotation applied to a mirror. The measurement part 108 can in such an embodiment be a photon detector, and the measurement signals can be photons.

In other embodiments the qubits can be implemented by electronic states of ions trapped in a magnetic field. The manipulation part 106 can in such a case utilize a laser, and the manipulation signals can cause the providing of control laser pulses. Moreover, in this case, the readout part 108 can be a photon detector combined with read-out laser pulses, and the measurement signals 102 may be photons. Other qubit implementations may be based on superconductors as quantum elements, semiconducting material with anyons as quantum elements, or the like.

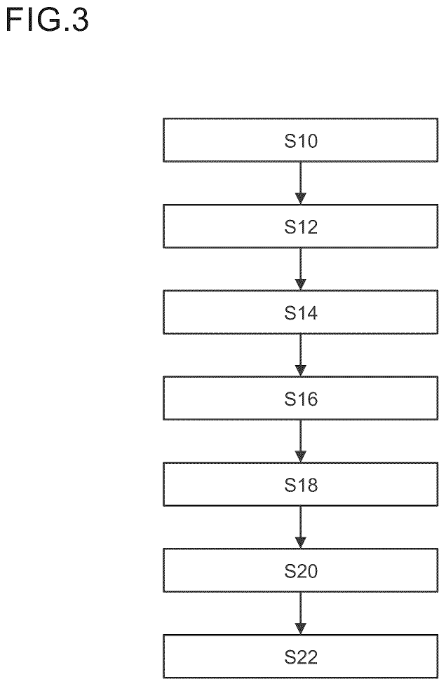

FIG. 3 illustrates a schematic exemplary method for generating a control signal to perform operations on the quantum computing device and for processing measurement signals from the quantum computing device. In most embodiments of quantum computing devices known to date, the control signals for the quantum computing device are prepared on a classical computing device and the measurement signals provided by the quantum computing device are further processed on the classical computing device. Other embodiments are, however, conceivable as quantum computing devices mature.

For generating the control signal to perform operations on the quantum computing device, the problem to be solved with the aid of the quantum computing device is provided in step S10, preferably, in a mathematical description. Such problem may for instance include determining a material property based on the mathematical description of the material's electronic structure. Other problems may include optimization problems and associated objective functions. Based on the problem to be solved, an operation description of the problem or a sub-problem may be generated in step S12, wherein the operation description comprises the operations to be applied to the qubits of the quantum computer to solve the problem in the quantum mechanical calculation. Further, the operation description can include a reference state that allows to generate a representation of an initial qubit state on the quantum computer on which the further operations are then applied by manipulating the qubit states. Based on the operation description control signals can then be generated in step S14 to control the quantum computer, for instance, by providing the control signals to the manipulation unit that can then manipulate the qubit states based on the control signals. In step S16 the manipulation unit then applies the manipulation operations to individual or multiple qubits of the quantum computer, wherein based on the manipulation operations the qubits perform the quantum mechanical calculation. After the manipulation, measurement signals can be generated to determine the result of the quantum mechanical calculation in step S18. This step can include a read-out, i.e. measurement, of the qubit states after applying the manipulation operations to the initial qubit states. The measurement signals can in step S20 then be translated into a measured quantity on the classical computer and in case of a sub-problem fed back into the problem to be solved. Finally, the result of the problem calculation including the quantum mechanical calculation can be provided on the classical computing device in step S22.

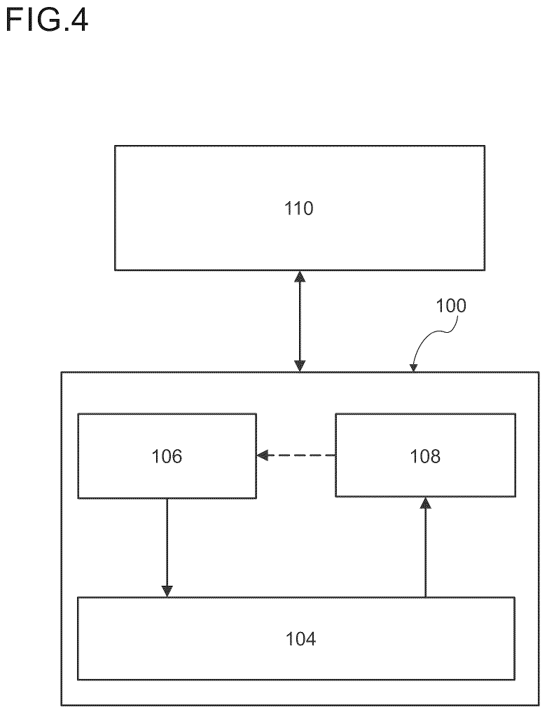

FIG. 4 illustrates a schematic example of a hybrid system including a classical and a quantum computing device. As described with respect to the method illustrated in FIG. 3, quantum computing devices are often used in connection with classical computing devices. As shown in FIG. 4 a problem preparation system can be realized as a classical computing device 110 performing, for instance, steps S10, S12, S20, S22 of the method illustrated in FIG. 3. A controlling unit can then be provided as interface between the classical computing device 110 and the quantum computer 100, wherein the controlling unit can also be a classical computing device, for instance, performing step S14. The control unit can then be communicatively coupled with the manipulation part 106 that can control the manipulators of the quantum computing device. Also, the manipulation part 106 can be realized as a classical computing device, for instance, a classical controlling hardware for the control of specific hardware components of the quantum computer that perform the manipulation of the qubit. However, the manipulation part 106 is generally regarded as part of the quantum computer, since it directly influences the quantum register. The quantum computing device 100 is adapted to perform the quantum operation S16, in particular, by the manipulation of the qubits of the quantum register. The measurement part 108 that is also generally regarded as part of the quantum computing device can then perform the step S18 by utilizing classical hardware. The measurement part 108 can then be communicatively coupled to the preparation system 110 for further processing of the measurement signals.

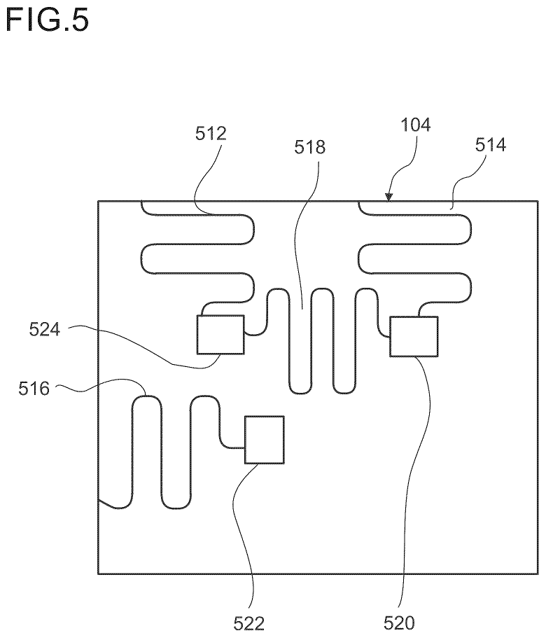

FIG. 5 illustrates a schematic example of a quantum computing device based on superconductors. Superconducting quantum computing devices are one of the solid-state quantum computing technologies. Here the quantum register 104 can include superconducting circuits 520, 522, 524 based on Josephson junctions. The qubits can then, for instance, refer to charge, flux, transmon, or phase qubits depending on the quantity of the superconducting circuits that are chosen to represent the qubits. FIG. 5 refers to a simplified illustration of a superconducting quantum computer utilizing charge qubits. For charge qubits the different states of the qubit are represented by an integer number of Cooper pairs on a superconducting island. Quantum operations can then be performed by manipulating the qubits through microwave pulses. Resonators 512, 514, 516 can be utilized to manipulate the state of the qubits by applying the microwaves or for reading out the state of the qubits by measuring respective microwaves, wherein generally different resonators are used for the manipulation of the state of the qubits and the readout of the qubits. Moreover, resonator 518 can be utilized for applying microwaves that entangle the qubits. However, instead of resonator 518 the entanglement can also be achieved by an inductive or capacitive coupling of the superconducting circuits or even by providing another qubit, here a superconducting circuit, between the to be entangled qubits.

On an operational level such systems are maintained at extremely low temperatures, e.g., in the tens of mK. The extreme cooling of the systems keeps superconducting materials below their critical temperature and helps to avoid unwanted state transitions. To maintain such low temperatures, the quantum information processing systems may be operated within a cryostat, such as a dilution refrigerator. In some implementations, control signals are generated in higher-temperature environments, and are transmitted to the quantum computer using shielded impedance-controlled GHz capable transmission lines, such as coaxial cables. In some implementations, the state measurement of superconducting qubits is achieved using a dispersive detection scheme. In order to read out or detect the state of any qubit, a probing signal, e.g., a travelling microwave, may be excited along a readout transmission line coupled to the qubit via a respective readout resonator. The frequency of the probing signal can be in the vicinity of the resonance frequency of the readout resonator. Depending on the internal quantum mechanical state of the qubit, the intensity or phase of the probing signal transmitted along the readout transmission line may be altered because the reflectivity of the readout resonator coupled to the qubit changes depending on the state of the qubit. This allows for the state detection of the qubits, wherein during the readout of a qubit state the state of the qubit collapses, i.e. is projected with the respective probability onto one of the basis states. By performing the quantum mechanical calculation and the readout a plurality of times the respective probabilities can be determined. Further details for superconducting quantum devices are described e.g. in Documents EP 3830867 A1, EP 3449427 A1, US 2020272925 A1, CN 212061223 U and US 2019019099 A1.

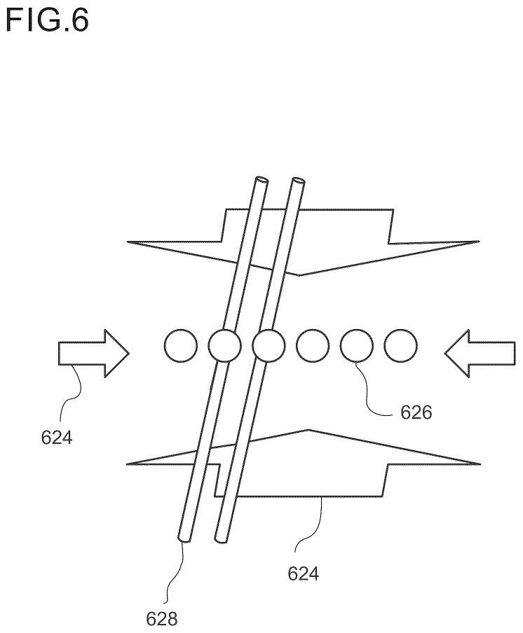

FIG. 6 illustrates a schematic example of a quantum computing device based on ions in an ion trap. Similar to neutral atom traps ion traps with, e.g. positively charged Calcium ions, can be used to implement the quantum computing device. Here ions 626 are trapped in an oscillating electromagnetic field 624 inside a high or ultra-high vacuum. The ions 626 are laser cooled and held in the oscillating electrical field 624. For qubit manipulation such as superposition or entanglement laser light 628 at different frequencies may be used.

Generally, based on the above described quantum computer realizations gate-model type calculations can be performed on a quantum computer hardware architecture. The gate-model type calculation is based on quantum gates. In contrast to classical gates, there is an infinite number of possible single-qubit quantum gates that can change the state vector of a qubit. Changing the state of a qubit state vector typically is referred to as a single qubit rotation, and may also be referred to herein as a state change or a single-qubit quantum gate operation. A rotation, state change, or single-qubit quantum gate operation can be represented mathematically by a unitary 2×2 matrix with complex elements. A rotation corresponds to a rotation of a qubit state within its Hilbert space, which can be conceptualized as a rotation of a vector on the Bloch sphere, wherein the Bloch sphere is generally known as a geometrical representation of the space of the pure states of a qubit. Multi-qubit gates alter the quantum state of a set of qubits. For example, two-qubit gates rotate the state of two qubits as a rotation in the four-dimensional Hilbert space of the two qubits, wherein, as generally known, the Hilbert space is an abstract vector space possessing the structure of an inner product that allows length and angle to be measured. Furthermore, Hilbert spaces are complete, i.e. there are enough limits in the space to allow the techniques of calculus to be used.

In the following the term operation description refers to a representation of a problem that comprises a sequence of quantum operations that should be applied during a quantum mechanical calculation of the problem. The term “quantum operation” can include in the context of this invention all types of quantum gates as described above. Moreover, the term can also include operations performed on components of the quantum computer representing a coupling between the quantum elements forming the qubits and bosonic fields and, optionally, components representing the bosonic fields themselves. These operations then refer to any kind of change of the state of the coupling or bosonic field representing components, for example, a turning of a coupling on and off, or the change of a field frequency, etc. Further, in some applications the quantum operations can also include measurement operations. This allows to implement algorithms using a measurement feedback. For example, in such an algorithm a quantum computer can execute the quantum gates defined by the sequence of quantum operations and then measure only a subset, i.e., fewer than all, of the qubits or other calculation elements, like the bosonic field states, in the quantum computer, and then decide which further quantum operations to execute next based on the outcome of the one or more measurements. In particular, measurement feedback can be useful for performing quantum error correction, but is not limited to use in performing quantum error correction.

In the following embodiments of the present invention are described, wherein differences to the above described generally known quantum computer devices are emphasized.

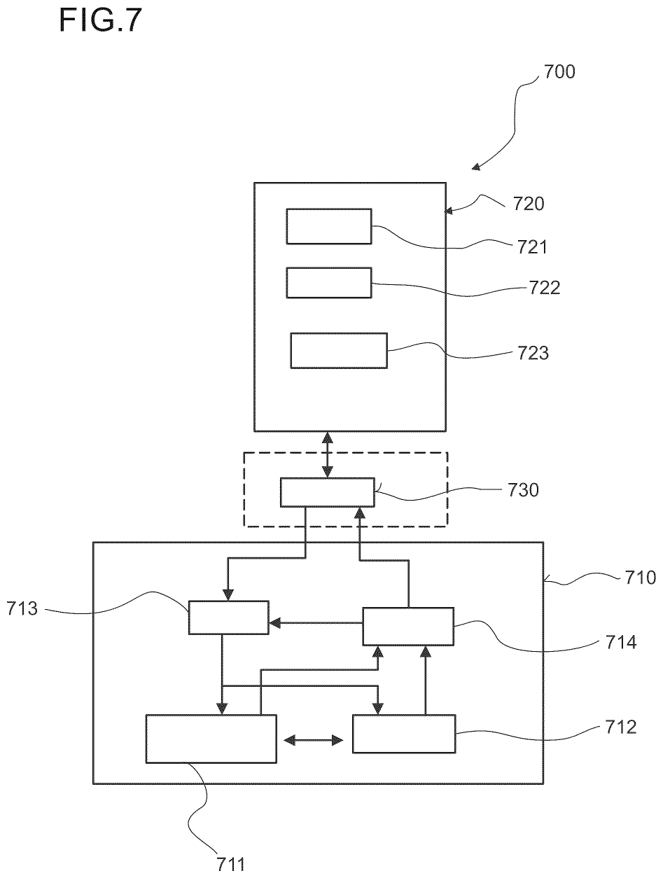

FIG. 7 shows schematically and exemplarily an embodiment of a system 700 for determining a solution of a problem, for instance, an electronic-structure problem, in a quantum computational calculation. The system is specifically adapted for solving a problem comprising a first and a second portion, wherein the first portion includes quantities describing the problem that interact with each other and the second portion includes quantities describing the problem that do not interact with each other. Preferably, the problem can be represented in a quantum mechanical description comprising as first portion fermion-boson interactions and optionally the bosonic fields that interact with the fermions but not among themselves and as second portion non-interacting fermions. Moreover, the problem can also comprise a third portion referring to only statically interacting quantities, wherein this third portion can preferably be represented in a quantum mechanical description as static fermion-fermion interactions.

The system comprises a quantum computer 710 and an apparatus 720. Further, a controlling unit 730 is shown as interface between the apparatus 720 and the quantum computer 710, wherein the controlling unit 730 can be either part of the apparatus 720 or part of the quantum computer 710 or can be distributed over both.

The quantum computer 710 comprises a fermion operation part 711 that is configured to utilize quantum mechanical states of quantum elements for forming qubits. For example, the fermion operation part can utilize and optionally also comprise a quantum register as described, for instance, with respect to FIG. 2. Generally, the quantum elements forming the qubits are manipulable by quantum gate operations performed on the quantum elements.

Further, the quantum computer 710 comprises in addition to the fermion operation part 711 and different from the generally known quantum computer as described in FIG. 2, a boson operation part 712. The boson operation part 712 is configured to couple bosonic fields to the quantum elements wherein the coupling of the bosonic fields to the quantum elements and optionally also the bosonic fields themselves are manipulable by quantum operations performed on a coupling of the bosonic fields and/or the bosonic fields themselves. Thus, as indicated by the two-sided arrow the fermion operation part 711 and the boson operation part 712 interact with each other through the coupling of the bosonic fields to the quantum elements that are utilized by the fermion operation part 711 such that the bosonic fields can influence the state of the quantum elements. Moreover, in preferred embodiments the interaction also comprises that the state of the quantum elements can influence the bosonic fields. Generally, the bosonic operation part 712 can be realized in a plurality of different ways depending on the construction principle on which the quantum computer 710 is based. For example, if the quantum computer 710 refers to a superconducting quantum computer in which the quantum elements are realized as superconducting circuits, as already explained above, the boson operation part 712 can be configured to utilize and, optionally, comprise additional resonators, i.e. resonators that are not used for the readout or operation of the quantum elements, as bosonic elements representing the bosonic fields, wherein the resonators are coupled to the quantum elements for providing the coupling of the bosonic fields to the quantum elements. Thus, in such an exemplary embodiment the bosonic fields will be represented by the electromagnetic fields provided by the resonators and the coupling will be represented by the interaction of the respective electromagnetic fields with the superconducting circuits forming the quantum elements. A more detailed description of this embodiment and also further exemplary embodiments of a realization of the boson operation part will be discussed with respect to the more detailed embodiments of the present invention.

Generally, the fermion operation part 711 is adapted to allow for a manipulation of the quantum elements by operations that are related to the second portion of the problem, that includes quantities describing the problem that do not interact with each other. In contrast thereto the boson operation part 712 is specifically configured to allow for manipulations by operations that are related to the first portion of the problem that refers to quantities describing the problem that interact with each other. Thus, by structuring the quantum computer 710 in contrast to the quantum computer as described in FIG. 2, to provide a fermion operation part 711 and additionally a boson operation part 712 it becomes possible to transfer the representation, i.e. simulation, of interacting quantities of the problem to an interaction of different parts of the quantum computer 710, for instance, to an interaction of additional resonators with superconducting circuits, that can be controlled independently. Moreover, it becomes possible that the boson operation part 712, due to the decoupling of the two portions of the problem, is represented by systems that are constructed to be controlled in a technically different manner than the quantum elements allowing to decrease the number of quantum gate operations that have to be performed explicitly on the qubits for solving a given problem. Thus, not only can a better control be provided that allows for an increase in the accuracy of the calculation, but further the necessary qubit resources can be decreased allowing for the calculation of more complex problems on given qubit resources.

Further, the quantum computer 710 comprises a manipulation part 713 that is configured to manipulate a) the fermion operation part 711 and b) the boson operation part 712. In particular, the manipulation part 713 is configured to manipulate the fermion operation part 711 such that the states of the quantum elements are manipulated based on control signals that are in particular indicative of operations that are related to the second portion of the problem, as described above. Moreover, the manipulation part 713 is configured to manipulate the boson operation part 712 such that the coupling of the bosonic fields and, optionally, also the bosonic fields themselves are manipulated based on control signals that are indicative of operations that are related to the first portion of the problem as described above. For example, the manipulation unit 713 can be regarded as a controller of a laser that can be regarded as being part of the fermion operation part 712 and that allows to manipulate the quantum elements, i.e. qubits, in quantum computers that are realized as ion traps. Alternatively, the manipulation 713 part can refer to a controller of a microwave source that is utilized to manipulate the qubits and/or the bosonic fields in a quantum computer that is realized as a superconducting quantum computer. Thus, the manipulation part 713 is provided with control signals, for instance, of the control unit 730 that are indicative of the operations that should be performed by the fermion operation part 711 and the boson operation part 712 and utilizes these control signals for controlling the respective part of the quantum computer accordingly.

Further, the quantum computer 710 comprises a readout part 714 that is configured to readout the quantum elements utilized by the fermion operation part 711 and the bosonic fields utilized by the boson operation part 712. Generally, the readout of the quantum elements and of the boson fields refers to measuring at least one observable of the quantum mechanical state of each quantum element utilized by the fermion operation part 711 and to measuring a state of a representation of the bosonic fields utilized by the boson operation part 712. The measurement of the bosonic fields, for instance, can refer to measuring an observable or signal provided by bosonic elements representing the bosonic fields. For example, if the quantum computer is a superconducting computer in which the bosonic fields are represented as resonators, the readout unit can be adapted to measure the electromagnetic field provided by the resonators or changes in this electromagnetic field. Alternatively, if the quantum computer refers to an ion trap quantum computer in which the bosonic fields are represented by vibrational modes of the trapped ions, the measurement unit can be adapted to measure a frequency of the vibrational modes of the trapped ions. The result of the measurement of the readout unit 714 is then indicative of the solution of the calculated problem.

Generally, the functioning of the quantum computer 710 can be controlled by a controlling unit 730. The controlling unit 730 is adapted to provide control signals to the manipulation part 713 that are indicative of the desired operations to be performed by the fermion operation part 711 and the boson operation part 712, wherein the manipulation part 713 then performs the respective manipulation, for instance, by controlling the laser or microwave source of the fermion operation part 711 or boson operation part 712, respectively. Moreover, the controlling unit 730 can also be adapted to control the readout unit 714 to readout after the performance of the operations the respective result of the quantum mechanical calculation. In particular, the readout part 714 can then be adapted to provide a signal indicative of the measured result to the controlling unit 730. Thus, generally the controlling unit 730 can be regarded as being part of the quantum computer 710. Moreover, the controlling unit 730 can even be realized as software and/or hardware together with the manipulation part 713, for instance, as part of a laser or microwave source controller. However, the controlling unit 730 can also be separate from the manipulation unit 713 and be provided in form of a separate software and/or hardware for controlling the quantum computer 710. Furthermore, the controlling unit 730 can also be realized as part of the apparatus 720 completely or partly. For example, the software providing the functions of the controlling unit 730 can be split between the apparatus 720 and the quantum computer 710 wherein each of the software parts provides computational functions that together provide the functions of the controlling unit 730. However also respectively dedicated hardware or software combinations can be split accordingly. Thus, generally the controlling unit 730 can be regarded as forming an interface between the apparatus 720 and the quantum computer 710.

In particular, the controlling unit 730 is configured to provide the control signals that control the manipulation part 713 such that the manipulation part 713 manipulates the fermion operation part 711 such that the states of the quantum elements are manipulated based on operations that are related to the second portion of the problem. Moreover, the control unit 730 is configured to provide the control signals that control the manipulation part 713 to manipulate the boson operation part 712 such that the coupling of the bosonic fields to the quantum elements is manipulated based on operations that are related to the first portion of the problem. Thus, the controlling unit 730 is specifically adapted to control the manipulation part 713 in accordance with the principle of providing the operations with respect to the different portions of the problem. Generally, the controlling unit 730 can be adapted to provide control signals that are already stored, for instance on a storage unit for the controlling of the manipulation part. However, the controlling unit 730 can also be adapted to generate the respective controlling signals, for instance, by working together with the apparatus 720. This preferred embodiment will be discussed in the following.

The apparatus 720 is, in particular, adapted for determining a solution of a problem as described above. However, although in the following embodiment, the apparatus is directly adapted to solve the problem, in other embodiments the apparatus 720 can be only be adapted to provide the control signals for controlling the determination of the solution on the quantum computer. In this case, the readout signals are provided to another unit and the result determination unit can be omitted.

The apparatus 720 comprises a problem providing unit 721 that is adapted for providing a problem description that is indicative of the problem comprising the first and second portion to be solved. Preferably, the problem description refers to a quantum mechanical description of the problem, for instance, to a quantum mechanical description of an electronic-structure problem. However, the problem description can refer to any other notation of a problem that unambiguously describes the problem to be solved, wherein in this case the translation unit 722 can be adapted to translate the provided problem description into a quantum mechanical description that can be solved on the quantum computer 710. The problem description can for instance, be stored on a storage unit and then provided by the problem providing unit 721 or can be received by the problem providing unit 721, for instance, via an input unit into which a user provides an input for the problem description. Thus, in a preferred embodiment the problem providing unit 721 refers to a user interface allowing a user to define the problem to be solved such that a problem description can be provided to the translation unit 722.

The translation unit 722 is then adapted to translate the problem description into a representative operation description, wherein optionally, if the problem description is not provided as a quantum mechanical description the translation unit 722 can also first translate the problem description into a quantum mechanical description of the problem. The representative operation description of the problem is indicative of a sequence of operations that should be performed on the quantum computer 710. For example, known algorithms and methods for translating a quantum mechanical problem description into respective operations on a quantum computer can be utilized as will be described for exemplarily realizations of the quantum computer 710 in the more detailed embodiments. In particular, the translation unit 722 is adapted to translate the problem description into a sequence of operations comprising a) second operations and b) first operations. The second operations are to be applied to the respective fermion operation part 711 of the quantum computer 710 and are determined based on the second portion of the problem. The first operations are to be applied to the boson operation part 712 of the quantum computer 710 and are thus determined based on the first portion of the problem. For example, the sequence of quantum operations can include respectively predetermined quantum gates for manipulating the qubits of the quantum computer 710 or can refer to operations for manipulating optional components of the boson operation part 712, for instance, if the bosonic fields are represented by respective additional components. The representative operation description indicative of the sequence of operations is then provided by the translation unit 722 to the controlling unit 730.

The controlling unit 730 is then adapted, as already described above, to act as an interface between the apparatus 720 and the quantum computer 710 and to provide or optionally generate, the control signals for controlling the manipulation part 713 such that the predetermined sequence of operations is performed. For example, the controlling unit 730 can be adapted to generate the control signals based on respective translation tables that translate predetermined operations as provided by the translation unit 722 into respective control signals that lead to the respective controlling of the manipulation part 713 for performing the operations. Such translation tables are generally then provided specifically with respect to the respective hardware and/or software utilized by the manipulation part 713.

Further, the controlling unit 730 provides control signals for controlling the readout unit 714, as described above, and receives from the readout unit 714 the readout one or more observables as result of the quantum mechanical calculation. In particular, the readout unit 714 is controlled to measure one or more observables of the quantum elements as states of the qubits. Further, the readout unit 714 is controlled to readout one or more observables of the bosonic fields, for instance, by measuring one or more observable representing the bosonic field like a frequency of a vibration of the trapped ions or a strength of an electromagnetic field of the resonators. These readout observables, i.e. measurement results, are then provided by the controlling unit 730 to the result determination unit 723 that is adapted to determine based on the one or more readout observables the solution of the problem. In particular, for determining the solution of the problem based on the readout observables the result determination unit can be adapted to perform further calculations or algorithms on the result. For example, the result determination unit 723 can be adapted to translate the one or more readout observables into the respective notation of the problem description for providing the solution of the problem. Moreover, the result determination unit 723 can also be adapted to apply more complex algorithms to the one or more readout observables, for instance, for error correction, or if the one or more readout observables are only indicative of a part of the solution of the problem. The result determination unit 723 can then be adapted to provide the result as solution of the problem to a user, for instance, via an output unit like a display. However, the result determination unit 723 can also be adapted to provide the result as solution of the problem as input to further computational systems, for instance, for a production controlling system for controlling an optimized production of a product. The result determination unit 723 can generally be part of the apparatus 720, but can also be a stand-alone device or part of another computer device.

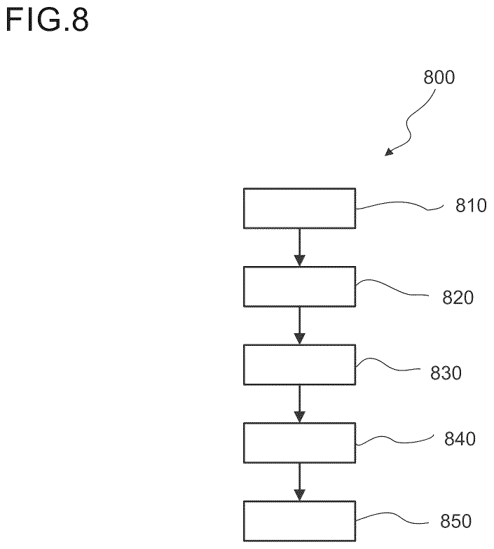

FIG. 8 shows schematically and exemplarily a flow chart of a method for determining a solution of a problem. In particular, the method 800 refers to a problem comprising a first and a second portion, wherein the first portion includes quantities describing the problem that interact with each other and the second portion includes quantities describing the problem that do not interact with each other. In particular, the method 800 is adapted to use a quantum computer as described above to perform the method. The method 800 comprises a first step 810 of providing a problem description indicative of the problem comprising the first and second portion to be solved. Generally, for this step 810 the same principles as described with respect, for instance, to the problem providing unit 721 can be applied. Further, the method 800 comprises a step 820 of translating the problem description into a representative operation description, wherein also here the step has already been described in more detail, for instance, with respect to the translating unit 722. Further, the method 800 comprises a step 830 of providing control signals for controlling the manipulation part of the quantum computer. In particular, the control signals lead to a controlling of the manipulation part to manipulate the fermion operation part such that the states of the quantum elements are manipulated based on the second operations and further the boson operation part is manipulated such that the coupling of the bosonic fields to the quantum elements is manipulated based on the first operations. This allows for a performance of the quantum mechanical calculation of the problem. In a next step 840 control signals are provided to control a readout part of the quantum computer to readout one or more observables after the performance of the quantum mechanical calculation, wherein the observables are indicative of the solution of the problem. In a last step 850 the method 800 comprises determining based on the one or more readout observables the solution of the problem.

In the following examples of preferred embodiments of the invention are provided in more detail, wherein the given examples mainly refer to problems provided in a quantum mechanical description relating to fermion-fermion, or fermion-boson interactions. However, as already discussed above, also other problems can be solved by the invention, in particular, if they can be translated in respective quantum mechanical descriptions. Generally, while quantum computers in principle allow for both highly efficient and highly accurate simulation of, for instance, many-fermion systems, the complexity of, in particular, fermion-fermion interactions proposes a challenge to near-term gate-based quantum computers, which are often limited by the number of quantum gates that can be carried out to manipulate the qubits, prepare the solution of the problem and finally read out the state of the qubit register. Furthermore, even on error-corrected quantum computers the complexity of fermion-fermion interactions can lead to long computation times as a large number of quantum gates is required. To simulate a fermion-fermion interaction that is described by 4-index vertices, as is generally the case for electronic-structure problems like molecules and solids, [symbol] (N⁴) quantum gate operations are required, where N is a measure for the problem size.

The invention as described above allows to implement, for instance, arbitrary fermion-fermion interactions on quantum computing architectures, e.g. superconducting or ion traps based quantum computers, while reducing the number of quantum gates to [symbol] (N²). If a problem is provided that is representable in a quantum mechanical description comprising, for instance, dynamic fermion-fermion interactions that can also refer to retarded or advanced interactions, it is preferred that the apparatus as described above further comprises a transformation unit adapted to transform the problem description into a problem description comprising boson-fermion interactions as first portion and non-interacting fermions as second portion. Thus, the transformation unit allows to map, for example, interacting fermions to a non-interacting system of fermions coupled to isolated bosonic fields. As already described above the quantum computational hardware is then modified specifically for solving the resulting problem. In the following the modifications to algorithms, approaches and existing hardware components for solving the problem are described in more detail with respect to preferred examples.

In the following we discuss preferred modifications of generally known quantum computers that can advantageously be used for solving the respective problems. Generally, it is preferred if the quantum elements forming the qubits that already exist in a hardware architecture are used, for instance, by the fermion operation part, for digital or analog simulation of portions of the problem that can be represented by non-interacting fermionic modes as second portion of the problem. Thus, the modifications mainly refer to the implementation of isolated bosonic modes and their coupling to the fermionic modes by introducing a bosonic operation part.

In a first preferred embodiment, the quantum computer refers to a superconducting quantum computer. In this case, the bosonic modes, i.e. bosonic fields, can be represented by, preferably, providing additional hardware resonators as boson elements, e.g. LC circuits, since, e.g., read-out resonators cannot be used for both readout and representation of bosonic modes. It is then preferred that [symbol] (N) additional resonators are arranged on a chip comprising the superconducting circuits forming the qubits. In particular, it is preferred that two to four additional resonators are provided per qubit, i.e. quantum element, and arranged such that they can be coupled to the respective qubit. For example, if the translation unit is adapted to apply a constrained random phase approximation to a quantum mechanical description of the problem, one resulting frequency-dependent interaction portion can be translated to quantum operations that are to be applied on two to four hardware resonators. In another example, in a case in which the quantum mechanical description of the problem comprises a 4-index interaction term as present in a molecular Hamiltonian, [symbol] (N²) additional resonators are preferably provided. Since this amount of resonators can be difficult to arrange in one chip, it is preferred that the translation unit is adapted to apply a low-rank decomposition on the quantum mechanical description of the problem in order to reduce the requirement to [symbol] (N) or [symbol] (N log N) resonators.

It can in some hardware realizations be challenging to provide resonators comprising a desired frequency for a specific problem since frequencies of resonators are often fixed within certain thresholds due to the fixed resonator length and the superconducting gap. In particular, if the quantum mechanical description of the problem comprises static fermion interactions high frequencies have to be provided by the resonators. In this case it is preferred that the translation unit of the apparatus is adapted to translate the quantum mechanical problem description into a rotating reference frame of the resonator, for instance, using a rotating wave approximation. Since this approach can still lead to complicated effective time evolutions of the hardware components, in a further preferred embodiment the boson operation part can be adapted to utilize an oscillating driving field for manipulating the coupling and/or bosonic fields.

Preferably, the coupling between the quantum elements and the resonators is configured to be digitally switchable and tuneable. In particular, the boson operation part can allow for a manipulation of the coupling strength. However, generally the coupling can be physically restricted, e.g. for Transmon qubits transversal coupling can be stronger than a longitudinal coupling, whereas for flux qubits the transversal and longitudinal coupling can be equally strong. Moreover, the coupling energy can physically be limited to approximately 10% of the qubit level splitting energy for Transmons. Preferably, a coupling energy of approximately 1% is used for the coupling.

When utilizing resonators to represent the bosonic fields two different time scales have to be synchronized during the quantum mechanical calculation. In particular, the simulated, for example, Trotterized time evolution of the qubits and the real, i.e. physical, time evolution of the resonators have to be synchronized. Preferably, in order to fulfil this condition the translation unit is adapted to translate the quantum mechanical description of the problem into quantum operations such that the simulated time is smaller or equal than the real time and by utilizing a waiting operation referring to a waiting time. During the waiting time operation no further operations are applied and the bosonic fields are allowed to interact with the quantum elements.

An advantage of the superconducting quantum computer as described above is that generally quantum operations and, in particular, quantum gates can be applied in parallel. This allows also the translation unit to take this parallelism into account when generating the sequence of quantum operations, for instance, by determining quantum operations of the sequence that can be applied at the same time. A further advantage is that the resonators allow to apply a broadening of bosonic peaks, e.g. via external fields or coupling of bosonic fields to ancilla qubits that can be measured to increase broadening. Further, it is also advantageously possible to measure the bosonic fields directly, for instance, by measuring characteristics of the field generated by each of the resonators.

In a further preferred embodiment the quantum computer utilized refers to a trapped ion quantum hardware. In particular, in this case the vibrational modes of the trapped ions can be used to represent bosonic modes, i.e. the bosonic fields. In this embodiment no hardware boson elements have to be provided for the representation of the bosonic fields. Instead the boson operation part can be configured such that the already present vibration modes of the trapped ions can be manipulated to interact, i.e. couple, to the electronic states of the trapped ions forming the qubits. Since the bosonic fields in this case are represented by the vibrational modes, the number of bosonic modes is naturally limited by the number of ions leading to approximately 3N bosonic fields.

Generally, it is preferred that the boson operation part allows for a manipulation of frequencies of the bosonic fields for providing energy to respective vibrational modes, to transfer energy from a vibrational mode to an electronic mode of a trapped ion or to transfer energy from an electronic mode to a vibrational mode. In case of an ion trapped ion quantum computer, the manipulation of the frequencies of the bosonic fields can be realized by manipulating the distance between trapped ions, for instance, by manipulating the electromagnetic fields trapping the ions in the ion trap, by manipulating the frequency of the laser that is used for manipulating the quantum elements or by utilizing a rotating frame. This allows to manipulate the coupling and/or the bosonic fields themselves very easily. Also in this case it is preferred that the translation unit is adapted to translate the quantum mechanical problem description into a rotating reference frame, wherein the rotating reference frame can be chosen more flexible due to the possibility of utilizing lasers for manipulating the vibrational modes. Moreover, it is preferred that the translation unit is adapted to provide an operation description of the problem comprising quantum operations that tune the laser to be in resonance with the frequencies of the fermionic and/or bosonic modes such that complicated time evolution effects are suppressed. Generally, in contrast to the above described realization of the superconducting quantum computer, in the ion trap realization the time scales of the time evolution of the qubits and the time evolution of the bosonic fields are identical, since both are realized by the same quantum mechanical system of trapped ions.

In contrast to superconducting hardware the coupling of the bosonic fields to the quantum elements can be regarded as being naturally implemented through the possibility of transferring energy from the vibrational modes to and/or from electronic states of the trapped ions. The boson operation part is thus preferably configured to allow for this coupling by controlling the coupling via laser pulses.

In an ion trap quantum computer quantum gates can generally only be applied in a serialized way. Thus, it is preferred that for this embodiment the translation unit is adapted to take this into account by providing the operation description such that the respective sequence of quantum operations only refers to quantum operations that are applied in a serial manner. However, if solutions are found that allow a parallel application of quantum operations on ion trap quantum computers, the translation unit can also take these new solutions into account.

Also in this case the translation unit can be adapted to utilize also quantum operations that lead to a broadening of bosonic peaks. Such quantum operations can refer, for instance, to a coupling of an external field to the bosonic fields or by utilizing ancilla qubits that can be measured to increase broadening.

Preferably, the translation unit is for this case adapted to apply a constrained random phase approximation to a quantum mechanical description of the problem, in particular, deriving effective electron-electron interactions. For such interactions provided by the problem, the above described hardware is particularly useful.

In a further preferred embodiment, instead of implementing the bosonic degrees of freedom as superconducting resonator lines or using vibrational modes in trapped ion hardware, they can also be implemented using specifically determined qubit gates on quantum elements. In this case the boson operation part is adapted to utilize an overhead in the number of quantum elements forming qubits to represent the bosonic fields and the coupling between the bosonic fields and the quantum elements representing the other quantities of the problem. Thus, in this embodiment it is preferred that the manipulation unit provides specific quantum operations for encoding the coupling and the bosonic fields in the overhead qubits. In this case it is preferred that the manipulation unit defines a cutoff threshold for the number of qubits that can be utilized for representing the bosonic fields, and thus provides a limit to the number of excitations in a bosonic mode that can be simulated. The threshold can be defined by utilizing a phenomenological approach.

Although in this embodiment the bosonic coupling is implemented also using quantum elements forming qubits, the sequence of quantum operations for a given problem does not necessarily also comprise substantially more quantum operations as in any of the above implementations, since the bosonic fields themselves do not interact and the time evolution can be applied in parallel to all bosonic fields as well as in parallel to the fermionic quantum elements. Moreover, the overhead quantum elements are preferably provided with less interaction possibilities than provided by the quantum elements dedicated for representing the non-interacting fermions. This has the advantage that this embodiment allows for an improved controllability at low excitation levels of bosonic modes.

Moreover, also other quantum computer architectures can be modified to allow for representing the bosonic fields and providing a boson operation part that allows for the implementation of a coupling between the bosonic fields and the quantum elements. For example, ultracold/Rydberg atom quantum hardware architectures, can also be utilized and modified in accordance with the above described principles.

In the following it is described in more detail how a problem, as described already above, can be solved using the respective specific quantum computer modifications. The following function can, for instance, be performed by respective units of the apparatus in order to provide the respective control signals related to quantum operations solving the problem on the quantum computer.

The following explanations are focused on the implementation utilizing a superconducting quantum computer with additional digitally switchable resonators for representing the bosonic fields. Such resonators provide more flexibility and are readily available for implementation in the hardware of the quantum computer. However, the general solutions discussed below can also, at least partly, be applied to other cases, in particular, also to other quantum computer hardware.

It is generally preferred that the translation unit is adapted to utilize a Trotterization algorithm to implement a time evolution of the Hamiltonian representing the quantum mechanical description of the problem. This leads in the frame of the respective problems to be solved and the approach of dividing the problem into first and second portions in some realizations of the quantum computer to an appearance of an additional time scale besides the simulated time scale. In particular, the time passing in the real world that is governing the evolution of some representations of the bosonic fields, like the above described resonators, deviates from the simulated time passing for the qubits. For such implementations it is preferred that the translation unit is adapted to translate the problem such into an operation description that the total real time elapsing during one Trotter step is equal to the simulated time of the Trotter step. Further, it is preferred that the boson operation part allows for a coupling of the bosonic field with the quantum elements that is strong enough to represent the effective simulated interaction between the bosonic field and the quantum elements, wherein in case of the superconducting quantum computer the effective interaction between a qubit and a resonator is given by the physical coupling scaled by the real-world simulation time and the simulated effective interaction strength is the coupling of a fermion with a bosonic field as determined by the Hamiltonian describing the problem scaled by the simulated time.

Moreover, it is preferred that the translation unit is adapted to translate the quantum mechanical description of the problem into a rotating reference frame. This allows, in particular, for the case utilizing resonators as boson elements to adjust the problem to the respective resonator frequencies. However, also in other quantum computer hardware realizations this translation can be advantageous. Utilizing this approach allows for an easier control of the representation of the bosonic modes on hardware component, but leads also to a more complex time evolution of the quantum mechanical description of the problem. Thus, it is further preferred that the translation unit applies the rotating wave approximation to the quantum mechanical description in the rotating reference frame which leads to a dropout of the most complicated terms, i.e. the terms with the highest rotation frequencies. Moreover, it is preferred that the manipulation part is adapted to allow for a frequency dependent manipulation of the quantum elements, bosonic fields and/or the coupling between the bosonic fields and the quantum elements. In particular, when applying the rotating wave approximation the frequency dependent manipulation allows to set the frequency of the manipulation of, for instance, the quantum elements, to a frequency that leads to a substantial cancelling of time evolution of respective terms in the quantum mechanical description, for instance, represented by the such manipulated quantum elements. In this way the influence of some of the terms of the quantum mechanical description can be reinforced and other terms can be neglected leading to a further simplification of the quantum mechanical calculation. In particular, the translation unit can then be adapted to include according quantum operations that refer to this frequency dependent manipulation to the sequence of quantum operations representing the problem.

In particular, utilizing the rotating frame allows to simulate frequency-dependent density-density interactions in a quantum mechanical description of the problem. If the rotating frame is utilized it is further preferred that the translation unit is adapted to provide respective phase quantum operations to the sequence of quantum operations representing the problem that allow the implementation of phase factors into the quantum mechanical calculation. Generally, these phase quantum operations can depend on the utilized hardware. For example, in an ion-trap quantum computer, the phase quantum operations can directly refer to a manipulation of the laser light used for manipulating the coupling, in other hardware realizations the phase quantum operations can refer to modified standard quantum gates to be applied to the qubits.

Generally, it is preferred that the translation unit is adapted to utilize the phase operations for translating the first portion of the problem that refers in the quantum mechanical description to a fermion-boson interaction to the operation description. In particular, the phase operations can refer to specifically modified standard quantum gates available on each quantum computer device hardware realization. Generally, while pure fermion-fermion interactions can be represented by standard single and two-qubit gates, the inclusion of bosonic modes leads to quantum operations that, preferably, also implement a phase depending on the state of the bosonic field, for instance, represented by an electromagnetic field in a resonator. In particular, the phase operations can refer to additional quantum gate operations followed by a waiting time during which the qubit, i.e. quantum element, and the representation of the bosonic field interact with each other in the real world.

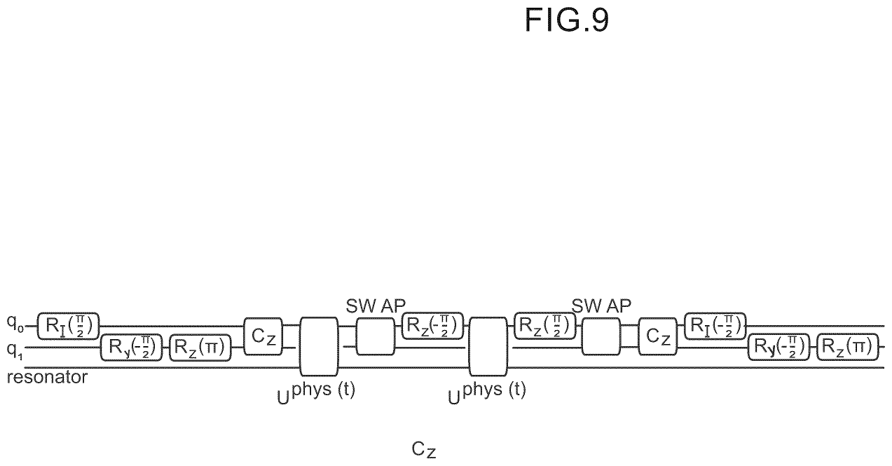

An example for a phase operation is described in the following referring to a modification of the known FSWAP algorithm that is used to implement an effective time evolution of the quantum mechanical system. With respect to the boson-fermion interaction the FSWAP gates need additionally to implement the phase shift due to the bosonic modes. This is achieved, as described already above, by introducing a waiting time, i.e., the time during which the representation of the bosonic field and a respective quantum element are allowed to interact with each other, into the sequence of FSWAP gates. The unitary matrix representation of a FSWAP gate reads

$${U}^{coupling} ( t ) = ( \begin{matrix}1 & 0 & 0 & 0 \\ 0 & cos ( g ( {b}^{†} + b ) t ) & - i sin ( g ( {b}^{†} + b ) t ) & 0 \\ 0 & - i sin ( g ( {b}^{†} + b ) t ) & cos ( g ( {b}^{†} + b ) t ) & 0 \\ 0 & 0 & 0 & 1\end{matrix} )$$

where b is the bosonic annihilation operator and b^{†} the bosonic creation operator, g describes a coupling strength between a fermion or a quantum element and a bosonic mode, and t is the waiting time. An example of a corresponding gate sequence is shown in FIG. 9. Boxes on the upper two lines represent gate operations performed on two respective qubits and boxes on the third line represent operations performed on the bosonic fields or the coupling of the bosonic field to the qubits. In the boxes the respective mathematical operator to which the operation refers in the quantum mechanical description of the problem is shown. In this example a decomposition of a FSWAP gate with phase shift due to the bosonic mode into Controlled-Z (CZ), SWAP gates, single-qubit gates and a boson gate denoted U^{phys} is shown. The boson gate taking into account the phase shift can in this case also be regarded as a phase operation and refers to a waiting time in which the interaction between the qubits and the bosonic fields takes place. Generally, decomposition, i.e. sequences of quantum operations, as described above can be provided for every quantum computer hardware realization accordingly.

Measuring, i.e. reading out, the Hamiltonian and other observables of the quantum mechanical system also preferably comprises a measurement of the bosonic field, for instance, of one or more observables of an electromagnetic field generated by the resonators. It is thus preferred that the readout part is adapted accordingly. Since qubit and boson operators commute, the readout part can be adapted to measure the observables of the quantum elements and the observables of the bosonic field simultaneously or sequentially. In the following processing of the measurement results a standard Hamiltonian averaging for the measurement can be used.

In preferred applications of the above-described quantum computer and methods, the problem can be translated into a quantum mechanical description referring to electrons moving in an electrical potential generated by atomic nuclei and interacting with each other via direct Coulomb repulsion or another, potentially, screened effective quasiparticle interaction. The following electronic system is a special case of a more generic fermionic system. Preferably, the fermionic system can be described in the quantum mechanical description by the following fermion-fermion Hamiltonian:

$${H}_{fermion} = {H}_{0} + {H}_{i n t} = {\sum }_{ij} {h}_{ij} {c}_{i}^{†} {c}_{j} + {\sum }_{ij kl} {U}_{ijkl} {c}_{i}^{†} {c}_{j}^{†} {c}_{k} {c}_{l}$$

Here, the cᵢ^{†} operator is the creation operator for a fermion in state i, which adds a fermion to that state, and cᵢ the annihilation operator removing a fermion from state i, hᵢⱼ describes non-interacting fermions moving in external potentials, from, e.g., nuclei or electromagnetic fields, wherein the external potentials can be time-dependent, e.g., for an oscillating electromagnetic field, or static, and Uᵢⱼₖₗ describes a time-independent fermion interaction, e.g., Coulomb repulsion for electrons.

Moreover, many problems that are of interest can be translated to fermionic systems dominated by density-density interactions. A famous example for such a system is the Fermi-Hubbard model. A density-density interaction is of the form

$${V}_{dd} = {\sum }_{ij} {U}_{ij} {c}_{i}^{†} {c}_{i} {c}_{j}^{†} {c}_{j} = {\sum }_{ij} {U}_{ij} {n}_{i} {n}_{j}$$

where nᵢ is the particle-number operator for the fermionic state i.

To apply the general principle of the invention of dividing a problem into a first, a second portion and optionally a third portion, it is preferred that in case the problem comprises terms representing interacting fermions, as the fermionic systems described above, the apparatus further comprises a transformation unit. The transformation unit is then adapted to transform the problem into a problem of the form comprising a first and second portion. In particular, if the problem is representable comprising a fermion-fermion interaction system, it is preferred that the transformation unit is adapted to transform the fermion-fermion interaction into boson-fermion interactions. Preferably, the transformation unit is adapted to utilize a Hubbard-Stratonovich transform for this case. The Hubbard-Stratonovich transform is a method known from solid-state field theory. It can be applied to fermionic quantum fields to decouple fermion-fermion interaction at the cost of newly introduced bosonic quantum fields coupled to the fermionic fields.

The application of the Hubbard-Stratonovich transform can lead to a fermion-boson system described in the following. Generally, the bosons are non-interacting among themselves, i.e. a boson does not interact with another boson. The Hubbard-Stratonovich transformation can lead for the Hamiltonian description above to a general fermion-boson Hamiltonian:

$${H}_{fermion} = {H}_{0} + {H}_{i n t} \to {H}_{fermion - boson} = {H}_{0} + {\sum }_{ijs} {g}_{ij , s} ( {b}_{s} + {b}_{s}^{†} ) {c}_{j}^{†} {c}_{i} + {\sum }_{s} {ω}_{s} {b}_{s}^{†} {b}_{s}$$

The fermion operators are the same as described with respect to the purely fermionic system above. The operator bₛ is a bosonic annihilation operator removing one boson from mode s and bₛ^{†} a creation operator adding a bosonic excitation to mode s. g_{ij,s} describes a coupling strength between bosonic mode s and fermion states i and j, for example from a Hubbard Stratonovich transform of the interacting fermionic system. The ωₛ are eigenfrequencies of the bosonic modes, for example, resonator frequencies on a superconducting device or phonon frequencies on an ion trap device. Thus, through the transformation the problem comprising interacting quantities is transformed into a system comprising a first portion referring to other interacting quantities, e.g. bosonic fields interacting with fermions, and a second portion referring to non-interacting quantities, e.g. non-interacting fermions. Generally, the application of the Hubbard-Stratonovich transformation can comprise applying the Hubbard-Stratonovich transformation to a quantum field representation of the interacting fermion operation part of the problem. Based on the result of the application a fermion-boson interacting system representing the interacting fermion operation part of the problem can be defined in form of a Hamiltonian that allows for utilizing known transformations in order to represent and calculate the Hamiltonian on a quantum computer. Generally, a quantum field representation of the fermion-boson system and a quantum field representation of the Hubbard-Stratonovich transformed interacting fermion operation part of the problem are identical if the fermion-boson system representation in the Hamiltonian is defined correctly. However, in some cases additional dynamic frequency dependent bosonic propagators appear in the field representation of the fermion-boson representation of the Hamiltonian. Generally, for some cases these additional bosonic propagators can generally be regarded as being small and can thus be neglected. However, in a preferred embodiment the bosonic operation part of the quantum computer, for example, the resonators, is controlled or adapted such that the bosonic propagators can be considered as being small and can be neglected. Further, it is preferred to fit the parameters g_{ij,s} describing the coupling strength between bosonic mode s and fermion states i and j, and ωₛ describing the eigenfrequencies of the bosonic modes in the Hamiltonian representation such that the boson operation part allows for an accurate representation of the calculated problem.

In order for the fermion-boson Hamiltonian shown above to be a good representation of the original fermion-fermion problem the dynamic frequency dependent bosonic propagator in the corresponding quantum field representation is neglected. However, in a further preferred embodiment this frequency dependence of the bosonic-fermionic coupling, i.e. the bosonic propagators, can also be utilized to advantage for problems translatable into fermionic systems with effective dynamical, i.e. frequency dependent, interactions. Typically, such effective dynamic frequency dependent fermionic interactions arise for problems where only a subsystem that is embedded in a larger system is computed. For example, such problems can refer to a quantum mechanical subsystem or embedded system, like those subsystems which are constructed by means of a cRPA calculation, where e.g. only the d-states are taken into account in the active part of the calculation and all other electronic states are integrated out and provide only an effective frequency dependent screening of the interaction between the active electrons. Another example could be an optically active molecule embedded into a larger molecule or protein, or a defect in a metal where the conduction electrons provide an effective screening.

In the following two preferred possibilities for this embodiment are described. For example, the problem description can be utilized to define for an electronic system an active space referring to spatial or molecular orbitals that are considered as being relevant for a specific problem. In particular, in this case an interacting fermion system can be split into two parts. Based on this split problem description the transformation unit can be adapted to utilize an embedding or screening method to calculate an influence of electrons outside the active space on the electrons within the active space. For example, the transformation unit can be adapted to apply a constrained random phase approximation calculation to the Hamiltonian to describe the inactive electrons as effective screening of the Coulomb interaction of the active electrons. This induces a frequency-dependent interaction in the many-body perturbation description, e.g. Green's function or action, of the active space for which no direct translation onto a Hamiltonian exists. However, to perform a calculation on the quantum computer usually such a representation is preferred. Thus, in this case the transformation unit is further adapted to applying a Hubbard-Stratonovich transform to the part of the problem description describing the active region under the influence of the screening by the remaining electrons. Thus, also in this case this is done by introducing additional bosonic fields and thus leading as in the first exemplary embodiment to a fermion-boson Hamiltonian, referring to a quantum mechanical description comprising first and second portions and optionally also a third portion. The action of this fermion-boson Hamiltonian has now a significantly frequency dependent interaction. In particular, this example leads to:

$${H}_{fermion - boson} = {H}_{0 , active} + {\sum }_{ijkl ∈ active} {U}_{ijkl} {c}_{i}^{†} {c}_{j}^{†} {c}_{k} {c}_{l} + {\sum }_{ij ∈ active} {\sum }_{s} {g}_{ij , s} ( {b}_{s} + {b}_{s}^{†} ) {c}_{j}^{†} {c}_{i} + {\sum }_{s} {ω}_{s} {b}_{s}^{†} {b}_{s}$$

Generally, the quantities in this equation refer to the quantities described already for the above equations. There is no Hamiltonian formulation for the dynamic interaction from the screening electrons. However, the fermion boson system with the Hamiltonian given above has the same action description as the fermion system with frequency dependent interaction and can thus be used to represent the system on the quantum computer. An advantage of this embodiment is that the screened Coulomb interaction and the dynamics of the bosonic fields in the active region can be mapped onto each other. This allows to use a wider variation of hardware for the realizing the problem on the quantum computer, for example, resonators with a much narrower frequency range can be utilized.

In a further example, the transformation unit is adapted to apply an extended dynamical mean-field theory (DMFT) calculation for a system with non-local interactions in the problem description, for instance, the general fermion-fermion Hamiltonian as defined above. In the DMFT an interacting cluster with local fermion interactions is embedded in the remaining non-local fermion interactions. In order to treat non-local long-range interactions, which reach outside the cluster, the transformation unit is adapted to apply a Hubbard-Stratonovich transform to the terms referring to the non-local interactions between the fermions. The resulting Hamiltonian of an effective boson-fermion system for the non-local interactions is used to calculate the corresponding propagators of this interaction on the quantum computer. These propagators can then, for instance, be used as input for a DMFT self-consistency loop, i.e. for iteratively calculating a solution for the complete problem.

Generally, for all problem descriptions it is preferred that the translation unit is adapted to translate the problem description into a representative operation description that comprises operations causing a bosonic peak broadening by including operations into the sequence of operations that utilize ancilla qubits and/or additional external electromagnetic fields that are configured to manipulate the coupling of the bosonic fields to the quantum elements. The broadening or line width of a bosonic peak spectral line can be artificially increased, in particular, with the help of ancilla qubits with a tunable coupling to the bosonic fields. Thus, it is preferred that the bosonic operation part is adapted to allow for such a tuneable coupling. Generally, in case of the quantum computer referring to a superconducting quantum computer comprising resonators to represent the bosonic fields, the broadening of the bosonic peaks is connected to an inverse of a quality factor of the resonator representing a respective bosonic field. Further, for superconducting quantum computers the broadening is proportional to a decay time of excitations in a resonator representing the respective bosonic field. In case of quantum computers realizing the bosonic fields as additional quantum elements, the broadening is connected to the error rate of the quantum elements. For quantum computers realized as trapped ion quantum computers the broadening relates to the decay time of an electronic state of the trapped ions and to fluctuations in an energy or an eigenfrequency of a vibration mode of the trapped ions, for instance, caused by the electromagnetic fields trapping the ions.

To increase the broadening of the bosonic peaks it is preferred that the following protocol is used, for instance, by translating the problem description to respective operations that cause the quantum computer to follow the respective protocol. First it is preferred that operations are applied that initialize an ancilla qubit in its ground state on the quantum computer. In the next step operations are applied that cause a SWAP operation between a bosonic field and the ancilla qubit. This transfers an excitation from the bosonic field to the ancilla qubit. In the last step an operation is applied that measures the ancilla qubit and rotates it back to its ground state if the ancilla qubit is measured in an excited state. The protocol can then be repeated if necessary.

This operation protocol effectively reduces the number of excitations of the bosonic field. Due to the measurement the protocol is not unitary. This non-unitary reduction of excitations corresponds to the typical decay of a bosonic field, for instance, represented by a resonator, and increases the line width of the bosonic field, i.e. leads to a bosonic peak broadening. The strength of the broadening can be controlled by the frequency, i.e. the number of repetitions per time unit, with which the protocol is applied.

In accordance with the invention as described above, it is preferred that the quantum computer, the apparatus and the method are applied to a problem comprising in its quantum mechanical description a system of fermions that interact with each other. The apparatus is then preferably adapted to translate the fermionic system into a coupled fermion-boson system. Further the apparatus is then adapted to translate the problem into a sequence of operations that lead to a mapping of all remaining fermionic modes, i.e. the non-interacting and the statically interacting fermions, to quantum elements and all bosonic modes to respective representations of the bosonic modes, for instance by providing respective control signals to the fermion operation parts and the boson operation parts of the quantum computer. Further, the determined sequence of operation allows preferably for a unitary evolution of the quantum mechanical calculation on the quantum computer. The apparatus then preferably is adapted to initiate a measurement of the states of the qubits and bosonic fields, for instance, by providing respective control signals to the readout part of the quantum computer, and to process the measurement result to get a final result for the original interacting fermionic system. Generally, the transformation used for transforming the fermion-fermion interactions into fermion-boson interactions defines a connection between the fermion-fermion interaction, the bosonic fields resonance frequencies and the qubit-bosonic fields coupling strength. This connection allows to fit the desired interaction using frequencies, width and coupling strength of the bosonic fields as represented by the respective utilized hardware. It can be controlled by allowing for a manipulation of the coupling strength between bosonic fields and the qubits, a manipulation of the bosonic fields resonance frequencies, the number of bosonic fields, and the width, i.e. quality factor of the bosonic fields. This manipulation can be based on respective quantum operations defined by the translation unit in accordance with the respective quantum mechanical problem description. Generally, a cost function for optimizing the fitting could be defined through a, optionally, weighted, area under peaks of the dynamical interaction, position of peaks, energy windows or hardware restrictions.

It is further preferred for all embodiments of the invention that the problem is representable in a quantum mechanical description comprising a fermionic system referring to a system of electrons.

Further, it is preferred for all embodiments of the invention that the transformation unit is adapted to utilize a Hubbard Stratonovich transformation to transform a portion of the problem that is representable in the quantum mechanical description as interacting fermions to a problem that is representable in the quantum mechanical description as an interaction between fermions and bosons. Generally, the Hubbard Stratonovich transform provides a connection between the fermion-fermion interaction, the bosonic fields resonance frequencies and the fermion-boson coupling strength. This connection allows to fit the desired interaction using bosonic frequencies, width and coupling strength.

It is further preferred for all embodiments of the invention that the translation unit is adapted to apply a low-rank decomposition on a quantum mechanical description of the problem, in particular, in order to reduce the number of bosonic fields required for solving the problem and to reduce the quantum mechanical description to a density-density type interaction, if necessary.

It is further preferred for all embodiments of the invention that the translation unit is adapted to translate the quantum mechanical description of the problem into a rotating reference frame. This allows to effectively control the effective resonator eigenfrequencies as seen by the fermionic system. If the original interaction refers to a density-density interaction this approach is particularly advantageous. For a generic case it is preferred that the translation unit includes quantum operations referring to additional resonant control pulses on bosonic modes into the operation description in order to suppress possible undesired resonances.

Moreover, the translation unit can further be adapted to apply a rotating wave approximation in order to simplify the effective time evolution during the quantum mechanical calculation.

It is further preferred for all embodiments of the invention that the boson operation part is configured to utilize external oscillating fields in order to control a broadening of the bosonic fields.

It is further preferred for all embodiments of the invention that the boson operation part is configured to couple ancilla qubits to bosonic fields in order to control the broadening of the bosonic fields. Moreover, the readout part can be adapted to further measure, based on provided control signals, the ancilla qubits to further increase the broadening of the bosonic field.

It is further preferred for all embodiments of the invention that portions of the problem representable in the quantum mechanical description referring to electron screening are calculated such that an effective frequency dependent screening interaction of electrons is provided that are not part of the active space calculation, for instance, by utilizing a constrained random phase approximation.

It is further preferred for embodiments of the invention that the transformation unit is adapted during the transformation of a quantum mechanical problem description to utilize a dynamic mean field theory (DMFT) and to apply to the resulting non-local fermion interactions and interactions of fermions that are not part of an active cluster, respectively, a Hubbard Stratonovich transformation. In another embodiment, a cRPA is utilized during the transformation of the quantum mechanical problem and the Hubbard Stratonovich transformation is applied to an active space of the problem. Resonance frequencies and coupling strengths of bosonic fields can then be determined by the translation unit, for instance, in the dynamic mean field theory algorithm using a self-consistency loop.

Generally, the already above described principles of the invention can be applied, in particular, to problems that can be represented in a quantum mechanical description as generic many-fermion systems. For example, the proposed principles can be combined with substantially any quantum simulation algorithm for electronic-structure problems on a quantum computer, like ground state algorithms, excited state algorithms, time evolution algorithms, Green's function algorithms, etc. Furthermore, for example, the algorithms described above can be combined with standard electronic-structure approaches like the resolution-of-the-identity (RI) approximation, exploitation of spatial and spin symmetries, e.g. point group symmetry, active space selection procedures, e.g. based on orbital entanglement information, single-orbital entropies, localization, population analysis, etc. Furthermore, the principles can also be combined with different Hamiltonian operators, e.g. Hamiltonian operators within the Born-Oppenheimer approximation, Hamiltonian operators including additional potentials, relativistic Hamiltonians, Hamiltonian operators including solvation models to describe the influence of solvents/environments, embedding techniques such as multi-scale approaches, e.g. ONIOM, QM/MM, etc.

In general, the invention as, for instance, described above can be used advantageously for the simulation of electronic-structure problems that can be divided into an active space and an environment/inactive space that is large enough to have continuous or quasi continuous states. More specific examples refer to the class of molecular problems. In particular, the above described principles of the invention can be applied to problems concerning metal-organic compounds containing transition metals, including lanthanides and actinides, i.e. strongly correlated homonuclear or oligonuclear centers in weakly correlated environments. For example, problems relating to chelating agents that interact with transition metals, wherein the chelating agents are, for instance, relevant for washing agents, or for selective extraction of metals in mining, etc. can be calculated. Moreover, problems with respect to catalysts, which are essential e.g. for producing homogenously catalyzed fine chemicals, active ingredients and polymers by enabling or accelerating the underlying chemical reactions under mild conditions can be solved. Also problems concerning large biomolecules with active centers, e.g. enzymes like peptidases and esterases, (bio-)macromolecular systems, and transition-metal compounds in solution or embedded in an environment in general, can be advantageously solved with the above described principles. Furthermore, the method is not limited to transition metal chemistry, but can also be advantageously applied in general to strongly correlated systems, e.g. in bond-breaking and -forming situations of organic molecules during a chemical reaction, for example, at the transition state and for the description of certain common main-group systems like ozone and polyenes.

The method is not limited to strongly correlated systems and can be applied to all electronic-structure problems.

For all examples mentioned above, the principles described above allow to calculate electronic energies that can then be utilized for the prediction of chemical reactivity, e.g. thermodynamics and kinetics of chemical reactions, spectroscopic properties, e.g. for photovoltaics, etc. Furthermore, physico-chemical properties beyond energies can be calculated via electronic-structure simulations, such as for example electrostatic multipole moments, hyperfine couplings, electric fields and their gradients relevant for Mossbauer spectroscopy, diamagnetic shieldings relevant for nuclear magnetic resonance (NMR) spectroscopy, etc.

Moreover, the above principles can also be applied to the class of condensed-matter problems. In the field of condensed-matter or solid-state physics related materials simulation the principles are in particular suitable to solve problems relating to transition metal oxides and rare earth elements containing materials. These include, but are not limited to Perovskites, e.g. used in solid oxide fuel cells, oxide-based battery cathodes, hard magnets for electric engines, catalysts for fuel cells, transition metal heterostructures for sensors, magnetic-semiconducting sandwich structures for spintronics and high-temperature superconductors. In all of these cases, starting from a density functional theory calculation, an all-electron calculation or any first principles or ab-initio calculation of the material of interest, a second quantized model of the relevant strongly correlated electronic states can be constructed, e.g. by means of maximally localized Wannier functions, density functional perturbation theory or constraint random phase approximation calculations, which can be solved highly efficiently utilizing the above described quantum computer, apparatus and method. Furthermore, any electronic or fermionic second-quantized materials model, which contains a frequency-dependent effective electron-electron or fermion-fermion interaction mediated by a bosonic mode, e.g. plasmons, magnons, phonons, etc., could be solved highly efficiently with a limited amount of necessary quantum computing resources when utilizing the principles described above.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the problem, the translating of the problem, the generating of the control signals, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

The invention refers to a quantum computer for performing operations based on control signals for determining a solution of a problem comprising a first and a second portion. A fermion operation part is configured to utilize states of quantum elements manipulable by operations. The operations are related to the second portion. A boson operation part is configured to couple bosonic fields to the quantum elements. The coupling is manipulable by operations that are related to the first portion. A manipulation part manipulates a) the fermion operation part based on operations related to the second portion, and b) the boson operation part based on operations that are related to the first portion. A readout part measures an observable of the a) state of each quantum element representing the state of a respective qubit and b) bosonic fields, wherein the result of the measurement is indicative of the solution of the problem.

1. A quantum computer for performing quantum operations based on control signals for determining a solution of a problem comprising a first and a second portion in a quantum computational calculation, wherein the first portion includes quantities describing the problem that interact with each other and the second portion includes quantities describing the problem that do not interact with each other, wherein the quantum computer comprises:
a fermion operation part configured to utilize quantum mechanical states of quantum elements for forming qubits that are manipulable by operations performed on the quantum elements, wherein the operations are related to the second portion of the problem to be solved during the quantum computational calculation of the problem,
a boson operation part configured to couple bosonic fields to the quantum elements, wherein the coupling of the bosonic fields to the quantum elements is manipulable by operations that are related to the first portion of the problem to be solved during the quantum computational calculation of the problem,
a manipulation part configured to manipulate a) the fermion operation part such that the states of the quantum elements are manipulated based on control signals indicative of operations that are related to the second portion of the problem to be solved during the quantum computational calculation of the problem, and b) the boson operation part such that the coupling of the bosonic fields to the quantum elements is manipulated based on control signals indicative of operations that are related to the first portion of the problem to be solved such that a quantum mechanical calculation of the problem is performed, and
a readout part configured to measure, after the manipulation of the quantum elements and the bosonic coupling for performing the quantum mechanical calculation, at least one observable of the a) quantum mechanical state of each quantum element representing the state of a respective qubit and b) bosonic fields, wherein the result of the measurement is indicative of the solution of the problem.

2. The quantum computer according to claim 1, wherein the quantum computer further comprises a controlling unit configured to provide control signals for controlling the manipulation part to manipulate a) the fermion operation part such that the states of the quantum elements are manipulated based on operations that are related to the second portion of the problem to be solved during the quantum computational calculation of the problem, and b) the boson operation part such that the coupling of the bosonic fields to the quantum elements is manipulated based on operations that are related to the first portion of the problem to be solved such that a quantum mechanical calculation of the problem is performed.

3. The quantum computer according to claim 1, wherein the bosonic coupling of the bosonic fields to the quantum elements is configured to be adaptable to represent a specific coupling of the first portion during the quantum computational calculation of the quantum mechanical problem, and wherein the manipulation part is further configured to adapt the coupling.

4. The quantum computer according to claim 1, wherein the boson operation part is configured to couple at least one bosonic field to each quantum element forming a qubit.

5. The quantum computer according to claim 1, wherein the quantum computer refers to
a) a superconducting quantum computer in which the quantum elements are realized as superconducting circuits and the coupling of the bosonic fields to the quantum elements is realized by providing electromagnetic resonators coupled to the superconducting circuits, or
b) an ion trap quantum computer, wherein the quantum elements are realized as ions trapped in an ion trap and the coupling of the bosonic fields to the quantum elements is realized as a coupling of vibrational modes of the trapped ions to electronic states of the trapped ions forming the qubits, or
c) any one type of quantum computer, wherein the bosonic coupling is realized by performing additional coupling operations on the quantum elements forming qubits.

6. An apparatus for providing control signals for controlling a quantum computer for determining a solution of a problem comprising a first and a second portion in a quantum computational calculation, wherein the first portion includes quantities describing the problem that interact with each other and the second portion includes quantities describing the problem that do not interact with each other, using the quantum computer according to claim 1, wherein the apparatus comprises:
a problem providing unit for providing a problem description indicative of the problem comprising the first and second portion to be solved,
a translation unit for translating the problem description into a representative operation description indicative of a sequence of operations comprising a) second operations to be applied to a fermion operation part of the quantum computer and b) first operations to be applied to boson operation part of the quantum computer, wherein the first operations are determined based on the first portion of the problem and the second operations are determined based on the second portion of the problem, and
a controlling unit for generating control signals for controlling a manipulation part of the quantum computer to manipulate a) the fermion operation part such that the states of the quantum elements are manipulated based on the second operations, and b) the boson operation part such that the coupling of the bosonic fields to the quantum elements is manipulated based on the first operations such that a quantum mechanical calculation of the problem is performed, wherein the controlling unit is further adapted to provide control signals for controlling a readout part of the quantum computer to readout one or more observables after the performance of the quantum mechanical calculation indicative of the solution of the problem.

7. The apparatus according to claim 6, wherein the problem providing unit is adapted to provide a problem description indicative of a problem comprising a portion with interacting quantities describing the problem, wherein the apparatus comprises further a transformation unit adapted to transform the interacting portion of the problem description into a problem description comprising a first and a second portion.

8. The apparatus according to claim 7, wherein the problem description is representable by a quantum mechanical description comprising fermion-fermion interactions and wherein the transformation unit is adapted to transform the problem description into a problem description representable by a quantum mechanical description comprising boson-fermion interactions as first portion of the problem and non-interacting fermions as second portion of the problem.

9. The apparatus according to claim 7, wherein the problem description comprises at least portions that are representable by a quantum mechanical description comprising a static fermion-fermion interaction as third portion of the problem and wherein the transformation unit is adapted to approximate these portions of the problem by utilizing a constrained random phase approximation.

10. The apparatus according to claim 6, wherein the problem description refers to a quantum mechanical description and wherein the translation unit is adapted to transform the quantum mechanical description of the problem into a rotating frame, in particular, by applying a rotating wave approximation, before the translation into the representative operation description.

11. The apparatus according to claim 7, wherein the problem description comprises at least portions that are representable by a quantum mechanical description comprising an interacting cluster with static local fermion interactions embedded in static non-local long-range interactions, which reach outside the cluster, as third portion of the problem and wherein the transformation unit is adapted to approximate these non-local long-range portions of the problem by utilizing a Hubbard-Stratonovich transformation.

12. A system for determining a solution of a problem in a quantum computational calculation, wherein the system comprises:
a quantum computer according to claim 1, and
an apparatus for providing control signals for controlling a quantum computer for determining a solution of a problem comprising a first and a second portion in a quantum computational calculation, wherein the first portion includes quantities describing the problem that interact with each other and the second portion includes quantities describing the problem that do not interact with each other, using the quantum computer according to claim 1, wherein the apparatus comprises:
a problem providing unit for providing a problem description indicative of the problem comprising the first and second portion to be solved,
a translation unit for translating the problem description into a representative operation description indicative of a sequence of operations comprising a) second operations to be applied to a fermion operation part of the quantum computer and b) first operations to be applied to boson operation part of the quantum computer, wherein the first operations are determined based on the first portion of the problem and the second operations are determined based on the second portion of the problem, and
a controlling unit for generating control signals for controlling a manipulation part of the quantum computer to manipulate a) the fermion operation part such that the states of the quantum elements are manipulated based on the second operations, and b) the boson operation part such that the coupling of the bosonic fields to the quantum elements is manipulated based on the first operations such that a quantum mechanical calculation of the problem is performed, wherein the controlling unit is further adapted to provide control signals for controlling a readout part of the quantum computer to readout one or more observables after the performance of the quantum mechanical calculation indicative of the solution of the problem,
wherein the apparatus further comprises a result determination unit for determining, based on the one or more readout observables, the solution for the problem.

13. A method for providing control signals for controlling a quantum computer for determining a solution of a problem comprising a first and a second portion in a quantum computational calculation, wherein the first portion includes quantities describing the problem that interact with each other and the second portion includes quantities describing the problem that do not interact with each other, using the quantum computer according to claim 1, wherein the method comprises:
providing a problem description indicative of the problem comprising the first and second portion to be solved,
translating the problem description into a representative operation description indicative of a sequence of operations comprising a) second operations to be applied to a fermion operation part of the quantum computer and b) first operations to be applied to boson operation part of the quantum computer, wherein the first operations are determined based on the first portion of the problem and the second operations are determined based on the second portion of the problem,
generating control signals for controlling a manipulation part of the quantum computer to manipulate a) the fermion operation part such that the states of the quantum elements are manipulated based on the second operations, and b) the boson operation part such that the coupling of the bosonic fields to the quantum elements is manipulated based on the first operations such that a quantum mechanical calculation of the problem is performed, and
providing control signals for controlling a readout part of the quantum computer to readout one or more observables after the performance of the quantum mechanical calculation indicative of the solution of the problem.

14. A computer program product for solving a problem, wherein the computer program product comprises program code means for causing an apparatus to execute the method according to claim 13,
wherein the apparatus is for providing control signals for controlling a quantum computer for determining a solution of a problem comprising a first and a second portion in a quantum computational calculation, wherein the first portion includes quantities describing the problem that interact with each other and the second portion includes quantities describing the problem that do not interact with each other, using a quantum computer, wherein the apparatus comprises:
a problem providing unit for providing a problem description indicative of the problem comprising the first and second portion to be solved,
a translation unit for translating the problem description into a representative operation description indicative of a sequence of operations comprising a) second operations to be applied to a fermion operation part of the quantum computer and b) first operations to be applied to boson operation part of the quantum computer, wherein the first operations are determined based on the first portion of the problem and the second operations are determined based on the second portion of the problem, and
a controlling unit for generating control signals for controlling a manipulation part of the quantum computer to manipulate a) the fermion operation part such that the states of the quantum elements are manipulated based on the second operations, and b) the boson operation part such that the coupling of the bosonic fields to the quantum elements is manipulated based on the first operations such that a quantum mechanical calculation of the problem is performed, wherein the controlling unit is further adapted to provide control signals for controlling a readout part of the quantum computer to readout one or more observables after the performance of the quantum mechanical calculation indicative of the solution of the problem,
wherein the quantum computer is for performing quantum operations based on control signals for determining a solution of a problem comprising a first and a second portion in a quantum computational calculation, wherein the first portion includes quantities describing the problem that interact with each other and the second portion includes quantities describing the problem that do not interact with each other, wherein the quantum computer comprises:
a fermion operation part configured to utilize quantum mechanical states of quantum elements for forming qubits that are manipulable by operations performed on the quantum elements, wherein the operations are related to the second portion of the problem to be solved during the quantum computational calculation of the problem,
a boson operation part configured to couple bosonic fields to the quantum elements, wherein the coupling of the bosonic fields to the quantum elements is manipulable by operations that are related to the first portion of the problem to be solved during the quantum computational calculation of the problem,
a manipulation part configured to manipulate a) the fermion operation part such that the states of the quantum elements are manipulated based on control signals indicative of operations that are related to the second portion of the problem to be solved during the quantum computational calculation of the problem, and b) the boson operation part such that the coupling of the bosonic fields to the quantum elements is manipulated based on control signals indicative of operations that are related to the first portion of the problem to be solved such that a quantum mechanical calculation of the problem is performed, and
a readout part configured to measure, after the manipulation of the quantum elements and the bosonic coupling for performing the quantum mechanical calculation, at least one observable of the a) quantum mechanical state of each quantum element representing the state of a respective qubit and b) bosonic fields, wherein the result of the measurement is indicative of the solution of the problem.

15. A method for solving electronic-structure problems comprising using the quantum computer according to claim 1.
